(19) United States
(12) Patent Application Publication
(10) Pub. No.: US 2026/0311631 A1
(43) Pub. Date: Oct. 8, 2026

(54) PIXEL CIRCUIT, DRIVING METHOD AND DISPLAY DEVICE

(71) Applicants: Beijing BOE Technology Development Co., Ltd., Beijing (CN); BOE TECHNOLOGY GROUP CO., LTD., Beijing (CN)

(72) Inventors: Minghua Xuan, Beijing (CN); Haoliang Zheng, Beijing (CN); Qi Qi, Beijing (CN)

(73) Assignees: Beijing BOE Technology Development Co., Ltd., Beijing (CN); BOE TECHNOLOGY GROUP CO., LTD., Beijing (CN)

(21) Appl. No.: 19/482,300

(22) PCT Filed: Apr. 17, 2024
(86) PCT No.: PCT/CN2024/088285

§ 371 Date: Nov. 7, 2025

(30) Foreign Application Priority Data
May 26, 2023 (CN) 202310611988.4

(51) Int. Cl. G09G 3/32; G09G 3/3233

(52) U.S. Cl. CPC G09G 3/32; G09G 3/3233; G09G 2300/0819; G09G 2300/0852; G09G 2310/08; G09G 2320/045

(57) ABSTRACT

The present disclosure provides a pixel circuit, a driving method, and a display device. In the pixel circuit, the first on-off control circuit controls connection or disconnection between a second node and a third node under control of a potential of a first control node; the second on-off control circuit controls connection or disconnection between a second electrode of the light emitting element and a first voltage terminal under control of a potential of a second control node; the first control circuit controls the potential of the first control node according to a first time control data voltage under control of a first control signal; and the second control circuit controls the potential of the second control node according to a second time control data voltage under control of a second control signal.

### CROSS-REFERENCE TO RELATED APPLICATION

This application claims priority to Chinese patent application No. 202310611988.4 filed in China on May 26, 2023, the entire contents of which are incorporated herein by reference.

### TECHNICAL FIELD

The present disclosure relates to the field of display technology, and in particular, to a pixel circuit, a driving method, and a display device.

### BACKGROUND

With the launch and promotion of Mini LED (mini light emitting diode) direct display products, Micro LED (micro light emitting diode) display technology is also imminent. The photoelectric characteristics of Micro LED and Mini LED have the characteristics of high photoelectric conversion efficiency under high current density, low photoelectric conversion efficiency under low current density, and different brightness and color shift between LED chips under low current density. As the size of LED decreases from Mini LED to Micro LED level, the proportion of photoelectric efficiency reduction caused by defects in the LED manufacturing process may increase, resulting in very low efficiency of Micro LED. Micro LED's low photoelectric efficiency and color and brightness issues at low current density mean that the pixel driving circuit used in Mini LED cannot be directly applied. Corresponding pixel circuits need to be developed based on the characteristics of Micro LED.

### SUMMARY

In a first aspect, an embodiment of the present disclosure provides a pixel circuit, comprising a driving circuit, a first on-off control circuit, a light emitting element, a second on-off control circuit, a first control circuit, and a second control circuit; wherein,
a first terminal of the driving circuit is electrically connected to a first node, and a second terminal of the driving circuit is electrically connected to a second node; the driving circuit is configured to generate a driving current for driving the light emitting element under control of a potential of a control terminal of the driving circuit;
the first on-off control circuit is configured to control connection or disconnection between the second node and a third node under control of a potential of a first control node;
a first electrode of the light emitting element is electrically connected to the third node;
the second on-off control circuit is configured to control connection or disconnection between a second electrode of the light emitting element and a first voltage terminal under control of a potential of a second control node;
the first control circuit is electrically connected to a first control terminal, a data line, a first light emitting time control terminal, a second light emitting time control terminal, and the first control node respectively, and is configured to control connection between the first light emitting time control terminal or the second light emitting time control terminal and the first control node according to a first time control data voltage provided by the data line under control of a first control signal provided by the first control terminal;
the second control circuit is electrically connected to a second control terminal, the data line, the second light emitting time control terminal, a third light emitting time control terminal and the second control node respectively, and is configured to control connection between the second light emitting time control terminal or the third light emitting time control terminal and the second control node according to a second time control data voltage provided by the data line under control of a second control signal provided by the second control terminal.

Optionally, the first control circuit comprises a first write circuit, a first energy storage circuit, a first switch control circuit and a second switch control circuit;
the first write circuit is electrically connected to the first control terminal, the data line and a first switch node respectively, and is configured to write the first time control data voltage into the first switch node under control of the first control signal provided by the first control terminal;
the first energy storage circuit is electrically connected to the first switch node, and is configured to maintain a potential of the first switch node;
the first switch control circuit is electrically connected to the first switch node, the second light emitting time control terminal, and the first control node respectively, and is configured to control connection or disconnection between the first control node and the second light emitting time control terminal under control of the potential of the first switch node;
the second switch control circuit is electrically connected to the first switch node, the first light emitting time control terminal and the first control node respectively, and is configured to control connection or disconnection between the first control node and the first light emitting time control terminal under control of the potential of the first switch node.

Optionally, the second control circuit comprises a second write circuit, a second energy storage circuit, a third switch control circuit, and a fourth switch control circuit;
the second write circuit is electrically connected to the second control terminal, the data line, and a second switch node respectively, and is configured to write the second time control data voltage provided by the data line into the second switch node under control of the second control signal provided by the second control terminal;
the second energy storage circuit is electrically connected to the second switch node, and is configured to maintain a potential of the second switch node;
the third switch control circuit is electrically connected to the second switch node, the third light emitting time control terminal, and the second control node respectively, and is configured to control connection or disconnection between the second control node and the third light emitting time control terminal under control of the potential of the second switch node;
the fourth switch control circuit is electrically connected to the second switch node, the second light emitting time control terminal and the second control node respectively, and is configured to control connection or disconnection between the second control node and the second light emitting time control terminal under control of the potential of the second switch node.

Optionally, the first control circuit comprises a third write circuit, a fourth write circuit, a fifth switch control circuit, a sixth switch control circuit, a third energy storage circuit, and a fourth energy storage circuit; the first control terminal comprises a first reset control terminal and a second reset control terminal;
the third write circuit is electrically connected to the first reset control terminal, the data line and a third switch node respectively, and is configured to write a third time control data voltage provided by the data line into the third switch node under control of a first reset control signal provided by the first reset control terminal:
the third energy storage circuit is electrically connected to the third switch node, and is configured to maintain a potential of the third switch node;
the fourth write circuit is electrically connected to the second reset control terminal, the data line and a fourth switch node respectively, and is configured to write a fourth time control data voltage provided by the data line into the fourth switch node under control of a second reset control signal provided by the second reset control terminal;
the fourth energy storage circuit is electrically connected to the fourth switch node, and is configured to maintain a potential of the fourth switch node;
the fifth switch control circuit is electrically connected to the third switch node, the second light emitting time control terminal, and the first control node respectively, and is configured to control connection or disconnection between the second light emitting time control terminal and the first control node under control of the potential of the third switch node;
the sixth switch control circuit is electrically connected to the fourth switch node, the first light emitting time control terminal and the first control node respectively, and is configured to control connection or disconnection between the first light emitting time control terminal and the first control node under control of the potential of the fourth switch node.

Optionally, the second control circuit comprises a fifth write circuit, a sixth write circuit, a seventh switch control circuit, an eighth switch control circuit, a fifth energy storage circuit, and a sixth energy storage circuit; and the second control terminal comprises a third reset control terminal and a fourth reset control terminal;
the fifth write circuit is electrically connected to the third reset control terminal, the data line and a fifth switch node respectively, and is configured to write a fifth time control data voltage provided by the data line into the fifth switch node under control of a third reset control signal provided by the third reset control terminal:
the fifth energy storage circuit is electrically connected to the fifth switch node, and is configured to maintain a potential of the fifth switch node;
the sixth write circuit is electrically connected to the fourth reset control terminal, the data line and a sixth switch node respectively, and is configured to write a sixth time control data voltage provided by the data line into the sixth switch node under control of a fourth reset control signal provided by the fourth reset control terminal;
the sixth energy storage circuit is electrically connected to the sixth switch node, and is configured to maintain a potential of the sixth switch node;
the seventh switch control circuit is electrically connected to the fifth switch node, the second light emitting time control terminal, and the second control node respectively, and is configured to control connection or disconnection between the second light emitting time control terminal and the second control node under control of the potential of the fifth switch node;
the eighth switch control circuit is electrically connected to the sixth switch node, the third light emitting time control terminal and the second control node respectively, and is configured to control connection or disconnection between the third light emitting time control terminal and the second control node under control of the potential of the sixth switch node.

Optionally, the driving circuit comprises a driving transistor;
a gate of the driving transistor is electrically connected to the control terminal of the driving circuit, a first electrode of the driving circuit is electrically connected to the first node, and a second electrode of the driving circuit is electrically connected to the second node;
the first on-off control circuit comprises a first control transistor, and the second on-off control circuit comprises a second control transistor;
a gate of the first control transistor is electrically connected to the first control node, a first electrode of the first control transistor is electrically connected to the second node, and a second electrode of the first control transistor is electrically connected to the third node;
a gate of the second control transistor is electrically connected to the second control node, a first electrode of the second control transistor is electrically connected to a second electrode of the light emitting element, and a second electrode of the second control transistor is electrically connected to the first voltage terminal.

Optionally, the first write circuit comprises a first transistor, the first energy storage circuit comprises a first capacitor, the first switch control circuit comprises a second transistor, and the second switch control circuit comprises a third transistor;
a gate of the first transistor is electrically connected to the first control terminal, a first electrode of the first transistor is electrically connected to the data line, and a second electrode of the first transistor is electrically connected to the first switch node;
a first terminal of the first capacitor is electrically connected to the first switch node, and a second terminal of the first capacitor is electrically connected to an initial voltage terminal;
a gate of the second transistor is electrically connected to the first switch node, a first electrode of the second transistor is electrically connected to the second light emitting time control terminal, and a second electrode of the second transistor is electrically connected to the first control node;
a gate of the third transistor is electrically connected to the first switch node, a first electrode of the third transistor is electrically connected to the first light emitting time control terminal, and a second electrode of the third transistor is electrically connected to the first control node.

Optionally, the second write circuit comprises a fourth transistor, the second energy storage circuit comprises a second capacitor, the third switch control circuit comprises a fifth transistor, and the fourth switch control circuit comprises a sixth transistor;
a gate of the fourth transistor is electrically connected to the second control terminal, a first electrode of the fourth transistor is electrically connected to the data line, and a second electrode of the fourth transistor is electrically connected to the second switch node;
a first terminal of the second capacitor is electrically connected to the second switch node, and a second terminal of the second capacitor is electrically connected to the initial voltage terminal;
a gate of the fifth transistor is electrically connected to the second switch node, a first electrode of the fifth transistor is electrically connected to the third light emitting time control terminal, and a second electrode of the fifth transistor is electrically connected to the second control node;
a gate of the sixth transistor is electrically connected to the second switch node, a first electrode of the sixth transistor is electrically connected to the second light emitting time control terminal, and a second electrode of the sixth transistor is electrically connected to the second control node.

Optionally, the third write circuit comprises a seventh transistor, the fourth write circuit comprises an eighth transistor, the third energy storage circuit comprises a third capacitor, the fourth energy storage circuit comprises a fourth capacitor, the fifth switch control circuit comprises a ninth transistor, and the sixth switch control circuit comprises a tenth transistor;
a gate of the seventh transistor is electrically connected to the first reset control terminal, a first electrode of the seventh transistor is electrically connected to the data line, and a second electrode of the seventh transistor is electrically connected to the third switch node;
a first terminal of the third capacitor is electrically connected to the third switch node, and a second terminal of the third capacitor is electrically connected to the initial voltage terminal;
a gate of the eighth transistor is electrically connected to the second reset control terminal, a first electrode of the eighth transistor is electrically connected to the data line, and a second electrode of the eighth transistor is electrically connected to the fourth switch node;
a first terminal of the fourth capacitor is electrically connected to the fourth switch node, and a second terminal of the fourth capacitor is electrically connected to the initial voltage terminal;
a gate of the ninth transistor is electrically connected to the third switch node, a first electrode of the ninth transistor is electrically connected to the second light emitting time control terminal, and a second electrode of the ninth transistor is electrically connected to the first control node;
a gate of the tenth transistor is electrically connected to the fourth switch node, a first electrode of the tenth transistor is electrically connected to the first light emitting time control terminal, and a second electrode of the tenth transistor is electrically connected to the first control node.

Optionally, the fifth write circuit comprises an eleventh transistor, the sixth write circuit comprises a twelfth transistor, the seventh switch control circuit comprises a thirteenth transistor, the eighth switch control circuit comprises a fourteenth transistor, the fifth energy storage circuit comprises a fifth capacitor, and the sixth energy storage circuit comprises a sixth capacitor;
a gate of the eleventh transistor is electrically connected to the third reset control terminal, a first electrode of the eleventh transistor is electrically connected to the data line, and a second electrode of the eleventh transistor is electrically connected to the fifth switch node;
a first terminal of the fifth capacitor is electrically connected to the fifth switch node, and a second terminal of the fifth capacitor is electrically connected to the initial voltage terminal;
a gate of the twelfth transistor is electrically connected to the fourth reset control terminal, a first electrode of the twelfth transistor is electrically connected to the data line, and a second electrode of the twelfth transistor is electrically connected to the sixth switch node;
a first terminal of the sixth capacitor is electrically connected to the sixth switch node, and a second terminal of the sixth capacitor is electrically connected to the initial voltage terminal;
a gate of the thirteenth transistor is electrically connected to the fifth switch node, a first electrode of the thirteenth transistor is electrically connected to the second light emitting time control terminal, and a second electrode of the thirteenth transistor is electrically connected to the second control node;
a gate of the fourteenth transistor is electrically connected to the sixth switch node, a first electrode of the fourteenth transistor is electrically connected to the third light emitting time control terminal, and a second electrode of the fourteenth transistor is electrically connected to the second control node.

Optionally, the pixel circuit according to at least one embodiment of the present disclosure further comprises a data write circuit, a compensation control circuit and a seventh energy storage circuit; wherein,
the data write circuit is electrically connected to a scan line, the data line and the first node respectively, and is configured to write a current control data voltage provided by the data line into the first node under control of a scan signal provided by the scan line;
the compensation control circuit is electrically connected to the scan line, the control terminal of the driving circuit and the second node respectively, and is configured to control connection or disconnection between the control terminal of the driving circuit and the second node under control of the scan signal;
the seventh energy storage circuit is electrically connected to the control terminal of the driving circuit and is configured to store electric energy.

Optionally, the pixel circuit according to at least one embodiment of the present disclosure further comprises a first initialization circuit and a second initialization circuit; wherein.
the first initialization circuit is electrically connected to the first control terminal, the initial voltage terminal, and the control terminal of the driving circuit respectively, and is configured to write an initial voltage provided by the initial voltage terminal into the control terminal of the driving circuit under control of the first control signal provided by the first control terminal;
the second initialization circuit is electrically connected to the first control terminal, the initial voltage terminal and the first electrode of the light emitting element respectively, and is configured to write the initial voltage into the first electrode of the light emitting element under control of the first control signal.

Optionally, the pixel circuit according to at least one embodiment of the present disclosure further comprises a light emitting control circuit; wherein,
the light emitting control circuit is electrically connected to the second light emitting time control terminal, a power supply voltage terminal and the first node respectively, and is configured to control connection between the power supply voltage terminal and the first node under control of the second light emitting time control signal provided by the second light emitting time control terminal.

Optionally, the first control terminal comprises the first reset control terminal and the second reset control terminal;
the pixel circuit further comprises a first initialization circuit and a second initialization circuit;
the first initialization circuit is electrically connected to the first reset control terminal, the initial voltage terminal, and the control terminal of the driving circuit respectively, and is configured to write the initial voltage provided by the initial voltage terminal into the control terminal of the driving circuit under control of the first reset control signal provided by the first reset control terminal;
the second initialization circuit is electrically connected to the first reset control terminal, the initial voltage terminal and the first electrode of the light emitting element respectively, and is configured to write the initial voltage into the first electrode of the light emitting element under control of the first reset control signal.

Optionally, the pixel circuit according to at least one embodiment of the present disclosure further comprises a compensation control circuit, a data write circuit, and an eighth energy storage circuit; wherein the first node is electrically connected to a power supply voltage terminal;
a first terminal of the eighth energy storage circuit is electrically connected to the control terminal of the driving circuit; and the eighth energy storage circuit is configured to store electrical energy;
the compensation control circuit is electrically connected to a scan line, the control terminal of the driving circuit, and the second node respectively, and is configured to control connection or disconnection between the control terminal of the driving circuit and the second node under control of a scan signal provided by the scan line;
the data write circuit is electrically connected to the scan line, the data line and a second terminal of the eighth energy storage circuit respectively, and is configured to write a current control data voltage provided by the data line into the second terminal of the eighth energy storage circuit under control of the scan signal.

Optionally, the pixel circuit according to at least one embodiment of the present disclosure further comprises a reference voltage write circuit;
the reference voltage write circuit is electrically connected to the first control terminal, the second light emitting time control terminal, a reference voltage terminal and the second terminal of the eighth energy storage circuit respectively, and is configured to write a reference voltage provided by the reference voltage terminal into the second terminal of the eighth energy storage circuit under control of the first control signal provided by the first control terminal, and to write the reference voltage into the second terminal of the eighth energy storage circuit under control of the second light emitting time control signal provided by the second light emitting time control terminal.

Optionally, the data write circuit comprises a fifteenth transistor, the compensation control circuit comprises a sixteenth transistor, and the seventh energy storage circuit comprises a first storage capacitor;
a gate of the fifteenth transistor is electrically connected to the scan line, a first electrode of the fifteenth transistor is electrically connected to the data line, and a second electrode of the fifteenth transistor is electrically connected to the first node;
a gate of the sixteenth transistor is electrically connected to the scan line, a first electrode of the sixteenth transistor is electrically connected to the control terminal of the driving circuit, and a second electrode of the sixteenth transistor is electrically connected to the second node;
a first terminal of the first storage capacitor is electrically connected to the control terminal of the driving circuit, and a second terminal of the first storage capacitor is electrically connected to a power supply voltage terminal.

Optionally, the first initialization circuit comprises a seventeenth transistor, and the second initialization circuit comprises an eighteenth transistor;
a gate of the seventeenth transistor is electrically connected to the first control terminal, a first electrode of the seventeenth transistor is electrically connected to the initial voltage terminal, and a second electrode of the seventeenth transistor is electrically connected to the control terminal of the driving circuit;
a gate of the eighteenth transistor is electrically connected to the first control terminal, a first electrode of the eighteenth transistor is electrically connected to the initial voltage terminal, and a second electrode of the eighteenth transistor is electrically connected to the first electrode of the light emitting element.

Optionally, the light emitting control circuit comprises a nineteenth transistor;
a gate of the nineteenth transistor is electrically connected to the second light emitting time control terminal, a first electrode of the nineteenth transistor is electrically connected to the power supply voltage terminal, and a second electrode of the nineteenth transistor is electrically connected to the first node.

Optionally, the first initialization circuit comprises a seventeenth transistor, and the second initialization circuit comprises an eighteenth transistor;
a gate of the seventeenth transistor is electrically connected to the first reset control terminal, a first electrode of the seventeenth transistor is electrically connected to the initial voltage terminal, and a second electrode of the seventeenth transistor is electrically connected to the control terminal of the driving circuit;
a gate of the eighteenth transistor is electrically connected to the first reset control terminal, a first electrode of the eighteenth transistor is electrically connected to the initial voltage terminal, and a second electrode of the eighteenth transistor is electrically connected to the first electrode of the light emitting element.

Optionally, the compensation control circuit comprises a sixteenth transistor, the data write circuit comprises a fifteenth transistor, and the eighth energy storage circuit comprises a second storage capacitor;
a first terminal of the second storage capacitor is electrically connected to the control terminal of the driving circuit;
a gate of the sixteenth transistor is electrically connected to the scan line, a first electrode of the sixteenth transistor is electrically connected to the control terminal of the driving circuit, and a second electrode of the sixteenth transistor is electrically connected to the second node;
a gate of the fifteenth transistor is electrically connected to the scan line, a first electrode of the fifteenth transistor is electrically connected to the data line, and a second electrode of the fifteenth transistor is electrically connected to a second terminal of the second storage capacitor.

Optionally, the reference voltage write circuit comprises a nineteenth transistor and a twentieth transistor;
a gate of the nineteenth transistor is electrically connected to the first control terminal, a first electrode of the nineteenth transistor is electrically connected to the reference voltage terminal, and a second electrode of the nineteenth transistor is electrically connected to the second terminal of the eighth energy storage circuit;
a gate of the twentieth transistor is electrically connected to the second light emitting time control terminal, a first electrode of the twentieth transistor is electrically connected to the reference voltage terminal, and a second electrode of the twentieth transistor is electrically connected to the second terminal of the eighth energy storage circuit.

In a second aspect, an embodiment of the present disclosure provides a driving method, applied to the above-mentioned pixel circuit, the driving method comprising:
a driving circuit generating a driving current for driving a light emitting element under control of a potential of a control terminal of the driving circuit;
a first on-off control circuit controlling connection or disconnection between a second node and a third node under control of a potential of a first control node;
a second on-off control circuit controlling connection or disconnection between a second electrode of the light emitting element and a first voltage terminal under control of a potential of a second control node;
a first control circuit controlling connection between a first light emitting time control terminal or a second light emitting time control terminal and the first control node according to a first time control data voltage provided by a data line under control of a first control signal;
a second control circuit controlling connection between the second light emitting time control terminal or a third light emitting time control terminal and the second control node according to a second time control data voltage provided by the data line under control of a second control signal.

In a third aspect, an embodiment of the present disclosure provides a display device, comprising the above-mentioned pixel circuit.

### BRIEF DESCRIPTION OF THE DRAWINGS

FIG. 1 is a structural diagram of a pixel circuit according to at least one embodiment of the present disclosure;

FIG. 2 is a structural diagram of a pixel circuit according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7 is a circuit diagram of a pixel circuit according to at least one embodiment of the present disclosure;

FIG. 8 is an operation timing diagram of at least one embodiment of the pixel circuit shown in FIG. 7 of the present disclosure;

FIG. 9A is a schematic diagram of the working state of at least one embodiment of the pixel circuit shown in FIG. 7 of the present disclosure in the first stage;

FIG. 9B is a schematic diagram of the working state of at least one embodiment of the pixel circuit shown in FIG. 7 of the present disclosure in the second stage;

FIG. 9C is a schematic diagram of the working state of at least one embodiment of the pixel circuit shown in FIG. 7 of the present disclosure in the third stage;

FIG. 9D is a schematic diagram of the working state of at least one embodiment of the pixel circuit shown in FIG. 7 of the present disclosure in the fourth stage;

FIG. 9E is a schematic diagram of the working state of at least one embodiment of the pixel circuit shown in FIG. 7 of the present disclosure in the fifth stage;

FIG. 10 is an operation timing diagram of at least one embodiment of the pixel circuit shown in FIG. 7 of the present disclosure;

FIG. 11 is an operation timing diagram of at least one embodiment of the pixel circuit shown in FIG. 7 of the present disclosure;

FIG. 12 is an operation timing diagram of at least one embodiment of the pixel circuit shown in FIG. 7 of the present disclosure;

FIG. 13 is a circuit diagram of a pixel circuit according to at least one embodiment of the present disclosure;

FIG. 14 is an operation timing diagram of at least one embodiment of the pixel circuit shown in FIG. 13 of the present disclosure;

FIG. 15 is a circuit diagram of a pixel circuit according to at least one embodiment of the present disclosure.

### DETAILED DESCRIPTION

The technical solutions in the embodiments of the present disclosure will be clearly and completely described below in conjunction with the drawings in the embodiments of the present disclosure. Obviously, the described embodiments are only part of the embodiments of the present disclosure, rather than all the embodiments. Based on the embodiments of the present disclosure, all other embodiments obtained by those skilled in the art without creative work shall fall within the scope of protection of the present disclosure.

The transistors used in all embodiments of the present disclosure may be thin film transistors, field effect transistors, or other devices with the same characteristics. In the embodiment of the present disclosure, in order to distinguish two electrodes of the transistor except a gate, one of the electrodes is referred to as a first electrode and the other electrode is referred to as a second electrode.

In actual operation, when the transistor is a thin film transistor or a field effect transistor, the first electrode may be a drain electrode, and the second electrode may be a source electrode; or, the first electrode may be a source electrode, and the second electrode may be a drain electrode.

The embodiments of the present disclosure provide a novel Micro LED pixel driving circuit to realize a high-quality Micro LED display device with lossless gamma. Through the pixel driving circuit and its matching timing, high grayscale, low grayscale, medium grayscale, and even super low grayscale can be achieved.

The Gamma 2.2 curve is a grayscale curve that is more suitable for human eyes. Usually, OLED (organic light emitting diode) display panels or LED display panels cannot fit the Gamma 2.2 curve at low grayscale or ultra-low grayscale due to intrinsic defects in their TFT (thin-film transistor) devices or defects in light emitting devices. Lossless gamma is achieved by coordinating several light emitting durations to ensure that all points of 8 bits (8 bits are 256 grayscales) or 10 bits (1024 grayscales) are on the Gamma 2.2 curve.

In at least one embodiment of the present disclosure, when there are 256 grayscales, L128 to L255 may be medium-high grayscales, L0 to L127 may be medium-low grayscales, L16 and below may be ultra-low grayscales, and low grayscales may be L17 to L127, where L128 is grayscale 128, L255 is grayscale 255, L0 is grayscale 0, L127 is grayscale 127, and L17 is grayscale 17;
but it is not limited to this.

The pixel circuit described in the embodiment of the present disclosure realizes different grayscales by coordinating current adjustment and light emitting time adjustment, and realizes medium-high grayscales, medium-low grayscales, low grayscales and ultra-low grayscales through different light emitting currents and duty cycles of light emitting time control signals provided by each light emitting time control terminal.

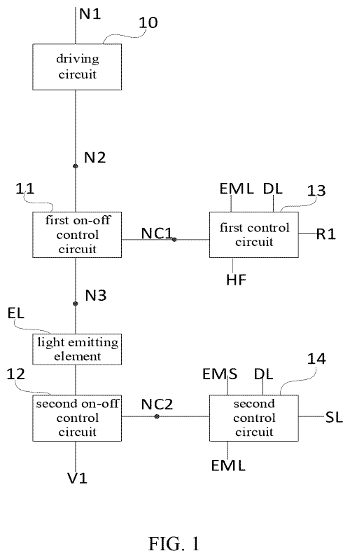

As shown in FIG. 1, the pixel circuit according to at least one embodiment of the present disclosure includes a driving circuit 10, a first on-off control circuit 11, a light emitting element EL, a second on-off control circuit 12, a first control circuit 13, and a second control circuit 14;
a first terminal of the driving circuit 10 is electrically connected to the first node N1, and a second terminal of the driving circuit 10 is electrically connected to the second node N2; the driving circuit 10 is configured to generate a driving current for driving the light emitting element EL under control of the potential of a control terminal of the driving circuit 10;
the first on-off control circuit 11 is electrically connected to the first control node NC1, the second node N2, and the third node N3 respectively, and is configured to control connection or disconnection between the second node N2 and the third node N3 under control of the potential of the first control node NC1;
a first electrode of the light emitting element EL is electrically connected to the third node N3;
the second on-off control circuit 12 is electrically connected to the second control node NC2, a second electrode of the light emitting element EL, and the first voltage terminal V1 respectively, and is configured to control the connection or disconnection between the second electrode of the light emitting element EL and the first voltage terminal V1 under control of the potential of the second control node NC2;
the first control circuit 13 is electrically connected to the first control terminal R1, the data line DL, the first light emitting time control terminal HF, the second light emitting time control terminal EML, and the first control node NC1 respectively, and is configured to control the connection between the first light emitting time control terminal HF or the second light emitting time control terminal EML and the first control node NC1 according to a first time control data voltage provided by the data line DL under control of a first control signal provided by the first control terminal R1;
the second control circuit 14 is electrically connected to the second control terminal SL, the data line DL, the second light emitting time control terminal EML, the third light emitting time control terminal EMS and the second control node NC2 respectively, and is configured to control the connection between the second light emitting time control terminal EML or the third light emitting time control terminal EMS and the second control node NC2 according to a second time control data voltage provided by the data line DL under control of a second control signal provided by the second control terminal SL.

Optionally, the first voltage terminal may be a low voltage terminal, but is not limited thereto.

When at least one embodiment of the pixel circuit shown in FIG. 1 of the present disclosure is in operation, a display cycle may include a first stage, a second stage, and a third stage that are sequentially arranged;
in the first stage, under control of the first control signal provided by the first control terminal R1, the first control circuit 13 controls the connection between the first light emitting time control terminal HF or the second light emitting time control terminal EML and the first control node NC1 according to the first time control data voltage provided by the data line DL;
when an ultra-low grayscale is displayed, the first control circuit 13 may control connection between the first light emitting time control terminal HF and the first control node NC1;
when a medium-high grayscale or a medium-low grayscale is displayed, the first control circuit 13 may control connection between the second light emitting time control terminal EML and the first control node NC1;
when a low grayscale is displayed, the first control circuit 13 may control connection between the first light emitting time control terminal HF and the first control node NC1;
the first light emitting time control terminal HF is configured to provide a first light emitting time control signal, and the second light emitting time control terminal EML is configured to provide a second light emitting time control signal;
the second stage is a compensation stage and a write time of a data voltage for controlling the light emitting current;
in the third stage, the second control circuit 14 controls connection between the second light emitting time control terminal EML or the third light emitting time control terminal EMS and the second control node NC2 according to the second time control data voltage provided by the data line DL under control of the second control signal;
when an ultra-low grayscale is displayed, the second control circuit 14 controls connection between the third light emitting time control terminal EMS and the second control node NC2;
when a medium-high grayscale is displayed, the second control circuit 14 controls connection between the second light emitting time control terminal EML and the second control node NC2;
when a medium-low grayscale is displayed, the second control circuit 14 controls connection between the third light emitting time control terminal EMS and the second control node NC2;
when a low grayscale is displayed, the second control circuit 14 controls connection between the third light emitting time control terminal EMS and the second control node NC2;
the third light emitting time control terminal EMS is configured to provide a third light emitting time control signal.

In a specific implementation, when the transistor included in the first on-off control circuit 11 is a p-type transistor, and the transistor included in the second on-off control circuit 12 is a p-type transistor, the duty cycle of the first light emitting time control signal provided by the first light emitting time control terminal HF is greater than the duty cycle of the third light emitting time control signal provided by the third light emitting time control terminal EMS, and the duty cycle of the third light emitting time control signal is greater than the duty cycle of the second light emitting time control signal provided by the second light emitting time control terminal EML;
when the transistor included in the first on-off control circuit 11 is an n-type transistor and the transistor included in the second on-off control circuit 12 is an n-type transistor, the duty cycle of the first light emitting time control signal provided by the first light emitting time control terminal HF is smaller than the duty cycle of the third light emitting time control signal provided by the third light emitting time control terminal EMS, and the duty cycle of the third light emitting time control signal is smaller than the duty cycle of the second light emitting time control signal provided by the second light emitting time control terminal EML;
but it is not limited to this.

In at least one embodiment of the present disclosure, the first control circuit includes a first write circuit, a first energy storage circuit, a first switch control circuit and a second switch control circuit;
the first write circuit is electrically connected to the first control terminal, the data line and the first switch node respectively, and is configured to write the first time control data voltage into the first switch node under control of the first control signal provided by the first control terminal;
the first energy storage circuit is electrically connected to the first switch node, and is configured to maintain the potential of the first switch node;
the first switch control circuit is electrically connected to the first switch node, the second light emitting time control terminal, and the first control node respectively, and is configured to control the connection or disconnection between the first control node and the second light emitting time control terminal under control of the potential of the first switch node;
the second switch control circuit is electrically connected to the first switch node, the first light emitting time control terminal and the first control node respectively, and is configured to control the connection or disconnection between the first control node and the first light emitting time control terminal under control of the potential of the first switch node.

In a specific implementation, the first control circuit may include a first write circuit, a first energy storage circuit, a first switch control circuit, and a second switch control circuit. The first write circuit writes the first time control data voltage into the first switch node under control of the first control signal. The first energy storage circuit maintains the potential of the first switch node. The first switch control circuit controls the connection or disconnection between the first control node and the second light emitting time control terminal under control of the potential of the first switch node; the second switch control circuit controls the connection or disconnection between the first control node and the first light emitting time control terminal under control of the potential of the first switch node.

In at least one embodiment of the present disclosure, the second control circuit includes a second write circuit, a second energy storage circuit, a third switch control circuit, and a fourth switch control circuit;
the second write circuit is electrically connected to the second control terminal, the data line and the second switch node respectively, and is configured to write the second time control data voltage provided by the data line into the second switch node under control of the second control signal provided by the second control terminal;
the second energy storage circuit is electrically connected to the second switch node, and is configured to maintain the potential of the second switch node;
the third switch control circuit is electrically connected to the second switch node, the third light emitting time control terminal, and the second control node respectively, and is configured to control the connection or disconnection between the second control node and the third light emitting time control terminal under control of the potential of the second switch node;
the fourth switch control circuit is electrically connected to the second switch node, the second light emitting time control terminal and the second control node respectively, and is configured to control the connection or disconnection between the second control node and the second light emitting time control terminal under control of the potential of the second switch node.

In a specific implementation, the second control circuit may include a second write circuit, a second energy storage circuit, a third switch control circuit and a fourth switch control circuit; the second write circuit writes the second time control data voltage into the second switch node under control of the second control signal; the second energy storage circuit maintains the potential of the second switch node; the third switch control circuit controls the connection or disconnection between the second control node and the third light emitting time control terminal under control of the potential of the second switch node; the fourth switch control circuit controls the connection or disconnection between the second control node and the second light emitting time control terminal under control of the potential of the second switch node.

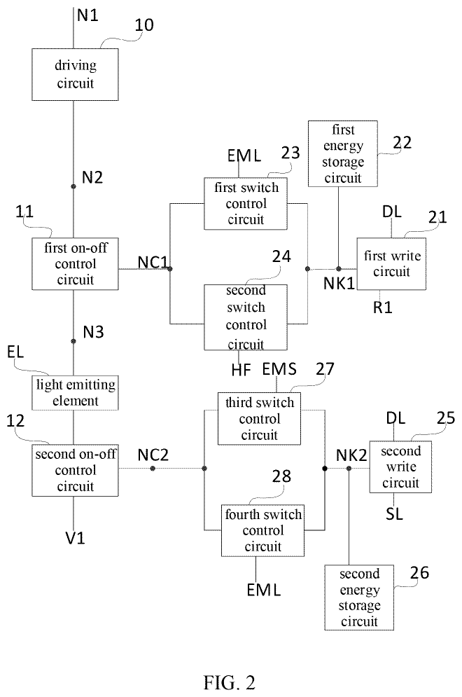

As shown in FIG. 2, based on at least one embodiment of the pixel circuit shown in FIG. 1, the first control circuit includes a first write circuit 21, a first energy storage circuit 22, a first switch control circuit 23 and a second switch control circuit 24;
the first write circuit 21 is electrically connected to the first control terminal R1, the data line DL and the first switch node NKI respectively, and is configured to write the first time control data voltage provided by the data line DL into the first switch node NK1 under control of the first control signal provided by the first control terminal R1;
the first energy storage circuit 22 is electrically connected to the first switch node NK1, and is configured to maintain the potential of the first switch node NK1;
the first switch control circuit 23 is electrically connected to the first switch node NK1, the second light emitting time control terminal EML, and the first control node NC1 respectively, and is configured to control the connection or disconnection between the first control node NC1 and the second light emitting time control terminal EML under control of the potential of the first switch node NK1;
the second switch control circuit 24 is electrically connected to the first switch node NK1, the first light emitting time control terminal HF, and the first control node NC1 respectively, and is configured to control the connection or disconnection between the first control node NC1 and the first light emitting time control terminal HF under control of the potential of the first switch node NK1;
the second control circuit includes a second write circuit 25, a second energy storage circuit 26, a third switch control circuit 27 and a fourth switch control circuit 28;
the second write circuit 25 is electrically connected to the second control terminal SL, the data line DL, and the second switch node NK2 respectively, and is configured to write the second time control data voltage provided by the data line DL into the second switch node NK2 under control of the second control signal provided by the second control terminal SL;
the second energy storage circuit 26 is electrically connected to the second switch node NK2, and is configured to maintain the potential of the second switch node NK2;
the third switch control circuit 27 is electrically connected to the second switch node NK2, the third light emitting time control terminal EMS, and the second control node NC2 respectively, and is configured to control the connection or disconnection between the second control node NC2 and the third light emitting time control terminal EMS under control of the potential of the second switch node NK2;
the fourth switch control circuit 28 is electrically connected to the second switch node NK2, the second light emitting time control terminal EML and the second control node NC2 respectively, and is configured to control the connection or disconnection between the second control node NC2 and the second light emitting time control terminal EML under control of the potential of the second switch node NK2.

When at least one embodiment of the pixel circuit shown in FIG. 2 of the present disclosure is in operation, a display cycle may include a first stage, a second stage, and a third stage that are sequentially arranged;
in the first stage, the first write circuit 21 writes the first time control data voltage provided by the data line DL into the first switch node NK1 under control of the first control signal provided;
when an ultra-low grayscale is displayed, the second switch control circuit 24 controls connection between the first control node NC1 and the first light emitting time control terminal HF under control of the potential of the first switch node NK1;
when a medium-high grayscale is displayed, the first switch control circuit 23 controls connection between the first control node NC1 and the second light emitting time control terminal EML under control of the potential of the first switch node NK1;
when a medium-low grayscale is displayed, the first switch control circuit 23 controls the connection between the first control node NC1 and the second light emitting time control terminal EML under control of the potential of the first switch node NK1;
when a low grayscale is displayed, the second switch control circuit 24 controls connection between the first control node NC1 and the first light emitting time control terminal HF under control of the potential of the first switch node NK1;
in the third stage, the second write circuit 25 writes the second time control data voltage provided by the data line DL into the second switch node NK2 under control of the second control signal provided by the second control terminal SL;
when an ultra-low grayscale is displayed, the third switch control circuit 27 controls connection between the second control node NC2 and the third light emitting time control terminal EMS under control of the potential of the second switch node NK2;
when a medium-high grayscale is displayed, the fourth switch control circuit 28 controls connection between the second control node NC2 and the second light emitting time control terminal EML under control of the potential of the second switch node NK2;
when a medium-low grayscale is displayed, the third switch control circuit 27 controls connection between the second control node NC2 and the third light emitting time control terminal EMS under control of the potential of the second switch node NK2;
when a low grayscale is displayed, the third switch control circuit 27 controls connection between the second control node NC2 and the third light emitting time control terminal EMS under control of the potential of the second switch node NK2.

In at least one embodiment of the present disclosure, the first control circuit includes a third write circuit, a fourth write circuit, a fifth switch control circuit, a sixth switch control circuit, a third energy storage circuit, and a fourth energy storage circuit; the first control terminal includes a first reset control terminal and a second reset control terminal;
the third write circuit is electrically connected to the first reset control terminal, the data line and the third switch node respectively, and is configured to write the third time control data voltage provided by the data line into the third switch node under control of the first reset control signal provided by the first reset control terminal;
the third energy storage circuit is electrically connected to the third switch node, and is configured to maintain the potential of the third switch node;
the fourth write circuit is electrically connected to the second reset control terminal, the data line and the fourth switch node respectively, and is configured to write the fourth time control data voltage provided by the data line into the fourth switch node under control of the second reset control signal provided by the second reset control terminal;
the fourth energy storage circuit is electrically connected to the fourth switch node, and is configured to maintain the potential of the fourth switch node;
the fifth switch control circuit is electrically connected to the third switch node, the second light emitting time control terminal, and the first control node respectively, and is configured to control the connection or disconnection between the second light emitting time control terminal and the first control node under control of the potential of the third switch node;
the sixth switch control circuit is electrically connected to the fourth switch node, the first light emitting time control terminal and the first control node respectively, and is configured to control the connection or disconnection between the first light emitting time control terminal and the first control node under control of the potential of the fourth switch node.

In a specific implementation, the first control circuit may include a third write circuit, a fourth write circuit, a fifth switch control circuit, a sixth switch control circuit, a third energy storage circuit and a fourth energy storage circuit; the first control terminal includes a first reset control terminal and a second reset control terminal; the third write circuit writes a third time control data voltage into the third switch node under control of a first reset control signal; the third energy storage circuit maintains the potential of the third switch node; the fourth write circuit writes a fourth time control data voltage into the fourth switch node under control of a second reset control signal; the fourth energy storage circuit maintains the potential of the fourth switch node; the fifth switch control circuit controls the connection or disconnection between the second light emitting time control terminal and the first control node under control of the potential of the third switch node; the sixth switch control circuit controls the connection or disconnection between the first light emitting time control terminal and the first control node under control of the potential of the fourth switch node.

In at least one embodiment of the present disclosure, the second control circuit includes a fifth write circuit, a sixth write circuit, a seventh switch control circuit, an eighth switch control circuit, a fifth energy storage circuit, and a sixth energy storage circuit; the second control terminal includes a third reset control terminal and a fourth reset control terminal;
the fifth write circuit is electrically connected to the third reset control terminal, the data line and the fifth switch node respectively, and is configured to write the fifth time control data voltage provided by the data line into the fifth switch node under control of the third reset control signal provided by the third reset control terminal;
the fifth energy storage circuit is electrically connected to the fifth switch node, and is configured to maintain the potential of the fifth switch node;
the sixth write circuit is electrically connected to the fourth reset control terminal, the data line and the sixth switch node respectively, and is configured to write the sixth time control data voltage provided by the data line into the sixth switch node under control of the fourth reset control signal provided by the fourth reset control terminal;
the sixth energy storage circuit is electrically connected to the sixth switch node, and is configured to maintain the potential of the sixth switch node;
the seventh switch control circuit is electrically connected to the fifth switch node, the second light emitting time control terminal, and the second control node respectively, and is configured to control the connection or disconnection between the second light emitting time control terminal and the second control node under control of the potential of the fifth switch node;
the eighth switch control circuit is electrically connected to the sixth switch node, the third light emitting time control terminal and the second control node respectively, and is configured to control the connection or disconnection between the third light emitting time control terminal and the second control node under control of the potential of the sixth switch node.

In a specific implementation, the second control circuit may include a fifth write circuit, a sixth write circuit, a seventh switch control circuit, an eighth switch control circuit, a fifth energy storage circuit and a sixth energy storage circuit; the second control terminal includes a third reset control terminal and a fourth reset control terminal; the fifth write circuit writes the fifth time control data voltage into the fifth switch node under control of the third reset control signal; the fifth energy storage circuit maintains the potential of the fifth switch node; the sixth write circuit writes the sixth time control data voltage into the sixth switch node under control of the fourth reset control signal; the sixth energy storage circuit maintains the potential of the sixth switch node; the seventh switch control circuit controls the connection or disconnection between the second light emitting time control terminal and the second control node under control of the potential of the fifth switch node; the eighth switch control circuit controls the connection or disconnection between the third light emitting time control terminal and the second control node under control of the potential of the sixth switch node.

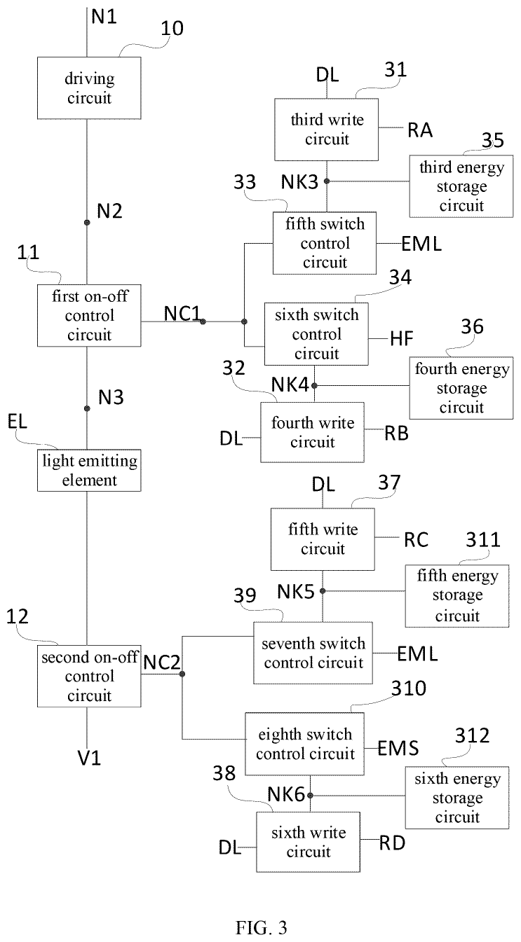

As shown in FIG. 3, based on at least one embodiment of the pixel circuit shown in FIG. 1, the first control circuit includes a third write circuit 31, a fourth write circuit 32, a fifth switch control circuit 33, a sixth switch control circuit 34, a third energy storage circuit 35, and a fourth energy storage circuit 36; the first control terminal includes a first reset control terminal RA and a second reset control terminal RB;
the third write circuit 31 is electrically connected to the first reset control terminal RA, the data line DL and the third switch node NK3 respectively, and is configured to write the third time control data voltage provided by the data line DL into the third switch node NK3 under control of the first reset control signal provided by the first reset control terminal RA;
the third energy storage circuit 35 is electrically connected to the third switch node NK3, and is configured to maintain the potential of the third switch node NK3;
the fourth write circuit 32 is electrically connected to the second reset control terminal RB, the data line DL and the fourth switch node NK4 respectively, and is configured to write the fourth time control data voltage provided by the data line DL into the fourth switch node NK4 under control of the second reset control signal provided by the second reset control terminal RB;
the fourth energy storage circuit 36 is electrically connected to the fourth switch node NK4, and is configured to maintain the potential of the fourth switch node NK4;
the fifth switch control circuit 33 is electrically connected to the third switch node NK3, the second light emitting time control terminal EML, and the first control node NC1 respectively, and is configured to control the connection or disconnection between the second light emitting time control terminal EML and the first control node NC1 under control of the potential of the third switch node NK3;
the sixth switch control circuit 34 is electrically connected to the fourth switch node NK4, the first light emitting time control terminal HF, and the first control node NC1 respectively, and is configured to control the connection or disconnection between the first light emitting time control terminal HF and the first control node NC1 under control of the potential of the fourth switch node NK4;
the second control circuit includes a fifth write circuit 37, a sixth write circuit 38, a seventh switch control circuit 39, an eighth switch control circuit 310, a fifth energy storage circuit 311 and a sixth energy storage circuit 312; the second control terminal includes a third reset control terminal RC and a fourth reset control terminal RD;
the fifth write circuit 37 is electrically connected to the third reset control terminal RC, the data line DL, and the fifth switch node NK5 respectively, and is configured to write the fifth time control data voltage provided by the data line DL into the fifth switch node NK5 under control of the third reset control signal provided by the third reset control terminal RC;
the fifth energy storage circuit 311 is electrically connected to the fifth switch node NK5, and is configured to maintain the potential of the fifth switch node NK5;
the sixth write circuit 38 is electrically connected to the fourth reset control terminal RD, the data line DL, and the sixth switch node NK6 respectively, and is configured to write the sixth time control data voltage provided by the data line DL into the sixth switch node NK6 under control of the fourth reset control signal provided by the fourth reset control terminal RD;
the sixth energy storage circuit 312 is electrically connected to the sixth switch node NK6, and is configured to maintain the potential of the sixth switch node NK6;
the seventh switch control circuit 39 is electrically connected to the fifth switch node NK5, the second light emitting time control terminal EML, and the second control node NC2 respectively, and is configured to control the commection or disconnection between the second light emitting time control terminal EML and the second control node NC2 under control of the potential of the fifth switch node NK5;
the eighth switch control circuit 310 is electrically connected to the sixth switch node NK6, the third light emitting time control terminal EMS and the second control node NC2 respectively, and is configured to control the connection or disconnection between the third light emitting time control terminal EMS and the second control node NC2 under control of the potential of the sixth switch node NK6.

When at least one embodiment of the pixel circuit shown in FIG. 3 of the present disclosure is in operation, a display cycle may include a first stage, a second stage, and a third stage that are sequentially arranged;
in the first stage, the third write circuit 31 writes the third time control data voltage provided by the data line DL into the third switch node NK3 under control of the first reset control signal provided by the first reset control terminal RA; the third energy storage circuit 35 maintains the potential of the third switch node NK3; the fourth write circuit 32 writes the fourth time control data voltage provided by the data line DL into the fourth switch node NK4 under control of the second reset control signal provided by the second reset control terminal RB; the fourth energy storage circuit 36 maintains the potential of the fourth switch node NK4;
when an ultra-low grayscale and a low grayscale are displayed, the sixth switch control circuit 34 controls connection between the first light emitting time control terminal HF and the first control node NC1 under control of the potential of the fourth switch node NK4;
when a medium-high grayscale and a medium-low grayscale are displayed, the fifth switch control circuit 33 controls connection between the second light emitting time control terminal EML and the first control node NC1 under control of the potential of the third switch node NK3;
in the third stage, the fifth write circuit 37 writes the fifth time control data voltage provided by the data line DL into the fifth switch node NK5 under control of the third reset control signal provided by the third reset control terminal RC; the fifth energy storage circuit 311 maintains the potential of the fifth switch node NK5; the sixth write circuit 38 writes the sixth time control data voltage provided by the data line DL into the sixth switch node NK6 under control of the fourth reset control signal provided by the fourth reset control terminal RD; the sixth energy storage circuit 312 maintains the potential of the sixth switch node NK6;
when an ultra-low grayscale, a medium-low grayscale, and a low grayscale are displayed, the eighth switch control circuit 310 controls the connection or disconnection between the third light emitting time control terminal EMS and the second control node NC2 under control of the potential of the sixth switch node NK6;
when a medium-high grayscale is displayed, the seventh switch control circuit 39 controls connection between the second light emitting time control terminal EML and the second control node NC2 under control of the potential of the fifth switch node NK5.

Optionally, the first write circuit includes a first transistor, the first energy storage circuit includes a first capacitor, the first switch control circuit includes a second transistor, and the second switch control circuit includes a third transistor;
a gate of the first transistor is electrically connected to the first control terminal, a first electrode of the first transistor is electrically connected to the data line, and a second electrode of the first transistor is electrically connected to the first switch node;
a first terminal of the first capacitor is electrically connected to the first switch node, and a second terminal of the first capacitor is electrically connected to the initial voltage terminal;
a gate of the second transistor is electrically connected to the first switch node, a first electrode of the second transistor is electrically connected to the second light emitting time control terminal, and a second electrode of the second transistor is electrically connected to the first control node;
a gate of the third transistor is electrically connected to the first switch node, a first electrode of the third transistor is electrically connected to the first light emitting time control terminal, and a second electrode of the third transistor is electrically connected to the first control node.

Optionally, the second write circuit includes a fourth transistor, the second energy storage circuit includes a second capacitor, the third switch control circuit includes a fifth transistor, and the fourth switch control circuit includes a sixth transistor;
a gate of the fourth transistor is electrically connected to the second control terminal, a first electrode of the fourth transistor is electrically connected to the data line, and a second electrode of the fourth transistor is electrically connected to the second switch node;
a first terminal of the second capacitor is electrically connected to the second switch node, and a second terminal of the second capacitor is electrically connected to the initial voltage terminal;
a gate of the fifth transistor is electrically connected to the second switch node, a first electrode of the fifth transistor is electrically connected to the third light emitting time control terminal, and a second electrode of the fifth transistor is electrically connected to the second control node;
a gate of the sixth transistor is electrically connected to the second switch node, a first electrode of the sixth transistor is electrically connected to the second light emitting time control terminal, and a second electrode of the sixth transistor is electrically connected to the second control node.

Optionally, the third write circuit includes a seventh transistor, the fourth write circuit includes an eighth transistor, the third energy storage circuit includes a third capacitor, the fourth energy storage circuit includes a fourth capacitor, the fifth switch control circuit includes a ninth transistor, and the sixth switch control circuit includes a tenth transistor;
a gate of the seventh transistor is electrically connected to the first reset control terminal, a first electrode of the seventh transistor is electrically connected to the data line, and a second electrode of the seventh transistor is electrically connected to the third switch node;
a first terminal of the third capacitor is electrically connected to the third switch node, and a second terminal of the third capacitor is electrically connected to the initial voltage terminal;
a gate of the eighth transistor is electrically connected to the second reset control terminal, a first electrode of the eighth transistor is electrically connected to the data line, and a second electrode of the eighth transistor is electrically connected to the fourth switch node;
a first terminal of the fourth capacitor is electrically connected to the fourth switch node, and a second terminal of the fourth capacitor is electrically connected to the initial voltage terminal;
a gate of the ninth transistor is electrically connected to the third switch node, a first electrode of the ninth transistor is electrically connected to the second light emitting time control terminal, and a second electrode of the ninth transistor is electrically connected to the first control node;
a gate of the tenth transistor is electrically connected to the fourth switch node, a first electrode of the tenth transistor is electrically connected to the first light emitting time control terminal, and a second electrode of the tenth transistor is electrically connected to the first control node.

Optionally, the fifth write circuit includes an eleventh transistor, the sixth write circuit includes a twelfth transistor, the seventh switch control circuit includes a thirteenth transistor, the eighth switch control circuit includes a fourteenth transistor, the fifth energy storage circuit includes a fifth capacitor, and the sixth energy storage circuit includes a sixth capacitor;
a gate of the eleventh transistor is electrically connected to the third reset control terminal, a first electrode of the eleventh transistor is electrically connected to the data line, and a second electrode of the eleventh transistor is electrically connected to the fifth switch node;
a first terminal of the fifth capacitor is electrically connected to the fifth switch node, and a second terminal of the fifth capacitor is electrically connected to the initial voltage terminal;
a gate of the twelfth transistor is electrically connected to the fourth reset control terminal, a first electrode of the twelfth transistor is electrically connected to the data line, and a second electrode of the twelfth transistor is electrically connected to the sixth switch node;
a first terminal of the sixth capacitor is electrically connected to the sixth switch node, and a second terminal of the sixth capacitor is electrically connected to the initial voltage terminal;
a gate of the thirteenth transistor is electrically connected to the fifth switch node, a first electrode of the thirteenth transistor is electrically connected to the second light emitting time control terminal, and a second electrode of the thirteenth transistor is electrically connected to the second control node;
a gate of the fourteenth transistor is electrically connected to the sixth switch node, a first electrode of the fourteenth transistor is electrically connected to the third light emitting time control terminal, and a second electrode of the fourteenth transistor is electrically connected to the second control node.

The pixel circuit according to at least one embodiment of the present disclosure further includes a data write circuit, a compensation control circuit and a seventh energy storage circuit;
the data write circuit is electrically connected to the scan line, the data line and the first node respectively, and is configured to write the current control data voltage provided by the data line into the first node under control of the scan signal provided by the scan line;
the compensation control circuit is electrically connected to the scan line, the control terminal of the driving circuit and the second node respectively, and is configured to control the connection or disconnection between the control terminal of the driving circuit and the second node under control of the scan signal;
the seventh energy storage circuit is electrically connected to the control terminal of the driving circuit and is configured to store electric energy.

In a specific implementation, the pixel circuit may further include a data write circuit, a compensation control circuit and a seventh energy storage circuit. The data write circuit writes the current control data voltage provided by the data line into the first node under control of the scan signal; the compensation control circuit controls the connection or disconnection between the control terminal of the driving circuit and the second node under control of the scan signal.

The pixel circuit according to at least one embodiment of the present disclosure further includes a first initialization circuit and a second initialization circuit;
the first initialization circuit is electrically connected to the first control terminal, the initial voltage terminal, and the control terminal of the driving circuit respectively, and is configured to write the initial voltage provided by the initial voltage terminal into the control terminal of the driving circuit under control of a first control signal provided by the first control terminal;
the second initialization circuit is electrically connected to the first control terminal, the initial voltage terminal and the first electrode of the light emitting element respectively, and is configured to write the initial voltage into the first electrode of the light emitting element under control of the first control signal.

In a specific implementation, the pixel circuit may further include a first initialization circuit and a second initialization circuit; the first initialization circuit, under control of the first control signal, writes the initial voltage provided by the initial voltage terminal into the control terminal of the driving circuit to initialize the potential of the control terminal of the driving circuit; the second initialization circuit, under control of the first control signal, writes the initial voltage into the first electrode of the light emitting element to initialize the potential of the first electrode of the light emitting element.

The pixel circuit according to at least one embodiment of the present disclosure further includes a light emitting control circuit;
the light emitting control circuit is electrically connected to the second light emitting time control terminal, the power supply voltage terminal and the first node respectively, and is configured to control the connection or disconnection between the power supply voltage terminal and the first node under control of the second light emitting time control signal provided by the second light emitting time control terminal.

In a specific implementation, the pixel circuit may further include a light emitting control circuit, which is configured to control the connection or disconnection between the power supply voltage terminal and the first node under control of the second light emitting time control signal provided by the second light emitting time control terminal to perform light emitting control.

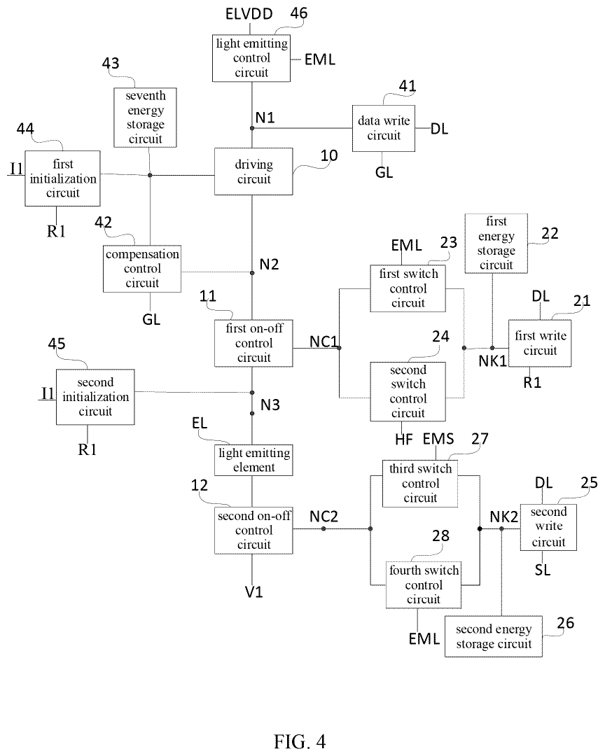

As shown in FIG. 4, based on at least one embodiment of the pixel circuit shown in FIG. 2, the pixel circuit according to at least one embodiment of the present disclosure may further include a data write circuit 41, a compensation control circuit 42, and a seventh energy storage circuit 43;
the data write circuit 41 is electrically connected to the scan line GL, the data line DL and the first node N1 respectively, and is configured to write the current control data voltage provided by the data line DL into the first node N1 under control of the scan signal provided by the scan line GL;
the compensation control circuit 42 is electrically connected to the scan line GL, the control terminal of the driving circuit 10, and the second node N2 respectively, and is configured to control the connection or disconnection between the control terminal of the driving circuit 10 and the second node N2 under control of the scan signal;
the seventh energy storage circuit 43 is electrically connected to the control terminal of the driving circuit 10 and is configured to store electrical energy;
the pixel circuit according to at least one embodiment of the present disclosure may further include a first initialization circuit 44 and a second initialization circuit 45;
the first initialization circuit 44 is electrically connected to the first control terminal R1, the initial voltage terminal I1, and the control terminal of the driving circuit 10 respectively, and is configured to write the initial voltage Vinit provided by the initial voltage terminal I1 into the control terminal of the driving circuit 10 under control of the first control signal provided by the first control terminal R1;
the second initialization circuit 45 is electrically connected to the first control terminal R1, the initial voltage terminal I1 and the first electrode of the light emitting element EL respectively, and is configured to write the initial voltage Vinit into the first electrode of the light emitting element EL under control of the first control signal;
the pixel circuit according to at least one embodiment of the present disclosure may further include a light emitting control circuit 46;
the light emitting control circuit 46 is electrically connected to the second light emitting time control terminal EML, the power supply voltage terminal ELVDD and the first node N1 respectively, and is configured to control the connection or disconnection between the power supply voltage terminal ELVDD and the first node N1 under control of the second light emitting time control signal provided by the second light emitting time control terminal EML.

When at least one embodiment of the pixel circuit shown in FIG. 4 of the present disclosure is in operation, a display cycle may include a first stage and a second stage that are sequentially arranged;
in the first stage, the first initialization circuit 44, under control of the first control signal provided by the first control terminal R1, writes the initial voltage Vinit provided by the initial voltage terminal I1 into the control terminal of the driving circuit 10, so that at the beginning of the second stage, the driving circuit 10 may conduct the connection between the first terminal and the second terminal thereof. The second initialization circuit 45, under control of the first control signal, writes the initial voltage Vinit into the first electrode of the light emitting element EL to control the light emitting element EL to not emit light and clear the residual charge in the first electrode of the light emitting element EL;
in the second stage, the data write circuit 41 writes the current control data voltage Vdata provided by the data line DL into the first node N1 under control of the scan signal provided by the scan line GL; the compensation control circuit 42 controls the connection between the control terminal of the driving circuit 10 and the second node N2 under control of the scan signal;
at the beginning of the second stage, the driving circuit 10 conducts the connection between the first node N1 and the second node N2 to charge the seventh energy storage circuit 43 through the current control data voltage Vdata, so as to increase the potential of the control terminal of the driving circuit 10 until the potential of the control terminal of the driving circuit 10 becomes Vdata+Vth, where Vth is the threshold voltage of the driving transistor included in the driving circuit 10. The driving circuit 10 disconnects the first node N1 and the second node N2 and stops charging to perform threshold voltage compensation.

In at least one embodiment of the present disclosure, the first control terminal includes a first reset control terminal and a second reset control terminal;
the pixel circuit further includes a first initialization circuit and a second initialization circuit;
the first initialization circuit is electrically connected to the first reset control terminal, the initial voltage terminal, and the control terminal of the driving circuit respectively, and is configured to write the initial voltage provided by the initial voltage terminal into the control terminal of the driving circuit under control of the first reset control signal provided by the first reset control terminal;
the second initialization circuit is electrically connected to the first reset control terminal, the initial voltage terminal and the first electrode of the light emitting element respectively, and is configured to write the initial voltage into the first electrode of the light emitting element under control of the first reset control signal.

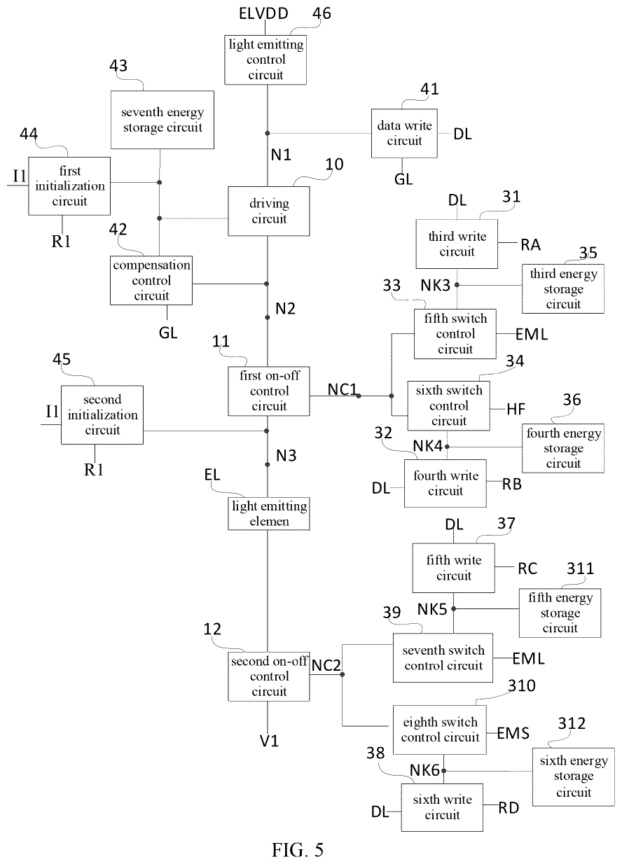

As shown in FIG. 5, based on at least one embodiment of the pixel circuit shown in FIG. 3, the pixel circuit according to at least one embodiment of the present disclosure may further include a data write circuit 41, a compensation control circuit 42, and a seventh energy storage circuit 43;
the data write circuit 41 is electrically connected to the scan line GL, the data line DL and the first node N1 respectively, and is configured to write the current control data voltage provided by the data line DL into the first node N1 under control of the scan signal provided by the scan line GL;
the compensation control circuit 42 is electrically connected to the scan line GL, the control terminal of the driving circuit 10, and the second node N2 respectively, and is configured to control the connection or disconnection between the control terminal of the driving circuit 10 and the second node N2 under control of the scan signal;
the seventh energy storage circuit 43 is electrically connected to the control terminal of the driving circuit 10 and is configured to store electrical energy;
the pixel circuit according to at least one embodiment of the present disclosure may further include a first initialization circuit 44 and a second initialization circuit 45;
the first initialization circuit 44 is electrically connected to the first reset control terminal RA, the initial voltage terminal I1, and the control terminal of the driving circuit 10 respectively, and is configured to write the initial voltage Vinit provided by the initial voltage terminal I1 into the control terminal of the driving circuit 10 under control of the first reset control signal provided by the first reset control terminal RA;
the second initialization circuit 45 is electrically connected to the first reset control terminal RA, the initial voltage terminal I1 and the first electrode of the light emitting element EL respectively, and is configured to write the initial voltage Vinit into the first electrode of the light emitting element EL under control of the first reset control signal;
the pixel circuit according to at least one embodiment of the present disclosure may further include a light emitting control circuit 46;
the light emitting control circuit 46 is electrically connected to the second light emitting time control terminal EML, the power supply voltage terminal ELVDD and the first node N1 respectively, and is configured to control the connection or disconnection between the power supply voltage terminal ELVDD and the first node N1 under control of the second light emitting time control signal provided by the second light emitting time control terminal EML.

When at least one embodiment of the pixel circuit shown in FIG. 5 of the present disclosure is in operation, a display cycle may include a first stage and a second stage that are sequentially arranged;
in the first stage, the first initialization circuit 44 writes the initial voltage Vinit provided by the initial voltage terminal I1 into the control terminal of the driving circuit 10 under control of the first reset control signal, so that at the beginning of the second stage, the driving circuit 10 may conduct the connection between the first terminal and the second terminal thereof. The second initialization circuit 45, under control of the first reset control signal, writes the initial voltage Vinit into the first electrode of the light emitting element EL to control the light emitting element EL to not emit light and clear the residual charge in the first electrode of the light emitting element EL;
in the second stage, the data write circuit 41 writes the current control data voltage Vdata provided by the data line DL into the first node N1 under control of the scan signal provided by the scan line GL; the compensation control circuit 42 controls the connection between the control terminal of the driving circuit 10 and the second node N2 under control of the scan signal;
at the beginning of the second stage, the driving circuit 10 conducts the connection between the first node N1 and the second node N2 to charge the seventh energy storage circuit 43 through the current control data voltage Vdata, so as to increase the potential of the control terminal of the driving circuit 10 until the potential of the control terminal of the driving circuit 10 becomes Vdata+Vth, where Vth is the threshold voltage of the driving transistor included in the driving circuit 10. The driving circuit 10 disconnects the first node N1 and the second node N2 and stops charging to perform threshold voltage compensation.

The pixel circuit according to at least one embodiment of the present disclosure further includes a compensation control circuit, a data write circuit, and an eighth energy storage circuit; the first node is electrically connected to the power supply voltage terminal;
a first terminal of the eighth energy storage circuit is electrically connected to the control terminal of the driving circuit; the eighth energy storage circuit is configured to store electrical energy;
the compensation control circuit is electrically connected to the scan line, the control terminal of the driving circuit and the second node respectively, and is configured to control the connection or disconnection between the control terminal of the driving circuit and the second node under control of the scan signal provided by the scan line;
the data write circuit is electrically connected to the scan line, the data line and the second terminal of the eighth energy storage circuit respectively, and is configured to write the current control data voltage provided by the data line into the second terminal of the eighth energy storage circuit under control of the scan signal.

The pixel circuit according to at least one embodiment of the present disclosure further includes a reference voltage write circuit;
the reference voltage write circuit is electrically connected to the first control terminal, the second light emitting time control terminal, the reference voltage terminal and the second terminal of the eighth energy storage circuit respectively, and is configured to write the reference voltage provided by the reference voltage terminal into the second terminal of the eighth energy storage circuit under control of the first control signal provided by the first control terminal, and to write the reference voltage into the second terminal of the eighth energy storage circuit under control of the second light emitting time control signal provided by the second light emitting time control terminal.

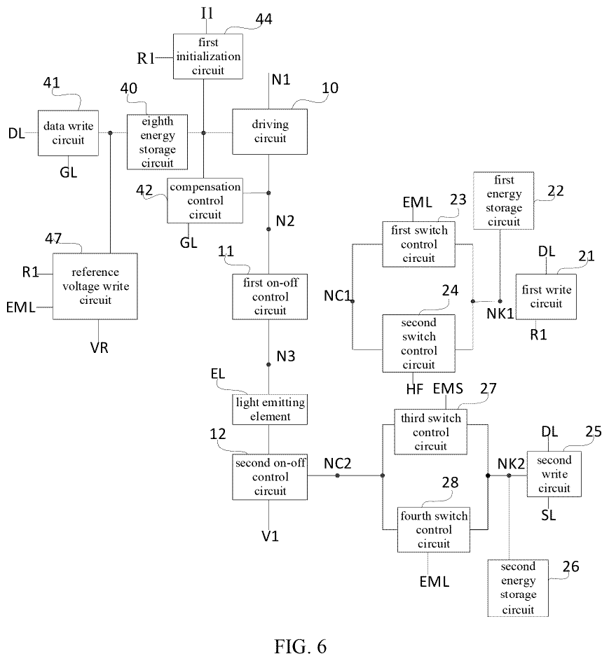

As shown in FIG. 6, based on at least one embodiment of the pixel circuit shown in FIG. 2,
the pixel circuit according to at least one embodiment of the present disclosure further includes a compensation control circuit 42, a data write circuit 41 and an eighth energy storage circuit 40; the first node N1 is electrically connected to the power supply voltage terminal ELVDD;
a first terminal of the eighth energy storage circuit 40 is electrically connected to the control terminal of the driving circuit 10; the eighth energy storage circuit 40 is configured to store electrical energy;
the compensation control circuit 42 is electrically connected to the scan line GL, the control terminal of the driving circuit 10, and the second node respectively, and is configured to control the connection or disconnection between the control terminal of the driving circuit 10 and the second node N2 under control of the scan signal provided by the scan line GL;
the data write circuit 41 is electrically connected to the scan line GL, the data line DL and the second terminal of the eighth energy storage circuit 40 respectively, and is configured to write the current control data voltage Vdata provided by the data line DL into the second terminal of the eighth energy storage circuit 40 under control of the scan signal;
the pixel circuit according to at least one embodiment of the present disclosure may further include a first initialization circuit 44;
the first initialization circuit 44 is electrically connected to the first control terminal R1, the initial voltage terminal I1, and the control terminal of the driving circuit 10 respectively, and is configured to write the initial voltage Vinit provided by the initial voltage terminal I1 into the control terminal of the driving circuit 10 under control of the first control signal provided by the first control terminal R1;
the pixel circuit according to at least one embodiment of the present disclosure further includes a reference voltage write circuit 47;
the reference voltage write circuit 47 is electrically connected to the first control terminal R1, the second light emitting time control terminal EML, the reference voltage terminal VR and the second terminal of the eighth energy storage circuit 40 respectively, and is configured to write the reference voltage Vref provided by the reference voltage terminal VR into the second terminal of the eighth energy storage circuit 40 under control of the first control signal provided by the first control terminal R1, and to write the reference voltage Vref into the second terminal of the eighth energy storage circuit 40 under control of the second light emitting time control signal provided by the second light emitting time control terminal EML.

When at least one embodiment of the pixel circuit shown in FIG. 6 of the present disclosure is in operation, a display cycle may include a first stage and a second stage that are sequentially arranged;
in the first stage, the first initialization circuit 44, under control of the first control signal provided by the first control terminal R1, writes the initial voltage Vinit provided by the initial voltage terminal I1 into the control terminal of the driving circuit 10, so that at the beginning of the second stage, the driving circuit 10 may conduct the connection between the power supply voltage terminal ELVDD and the second node N2; the reference voltage write circuit 47, under control of the first control signal, writes the reference voltage Vref provided by the reference voltage terminal VR into the second terminal of the eighth energy storage circuit 40, so as to initialize the potential of the second terminal of the eighth energy storage circuit 40, so that the potential of the second terminal of the eighth energy storage circuit 40 is Vref;
in the second stage, the data write circuit 41 is electrically connected to the scan line GL, the data line DL and the second terminal of the eighth energy storage circuit 40 respectively, and is configured to write the current control data voltage Vdata provided by the data line DL into the second terminal of the eighth energy storage circuit 40 under control of the scan signal; the compensation control circuit 42, under control of the scan signal, controls the connection between the control terminal of the driving circuit 10 and the second node N2 to charge the eighth energy storage circuit 40 until the driving circuit 10, under control of the potential of its control terminal, disconnects the power supply voltage terminal ELVDD and the second node N2 to perform threshold voltage compensation.

Optionally, the data write circuit includes a fifteenth transistor, the compensation control circuit includes a sixteenth transistor, and the seventh energy storage circuit includes a first storage capacitor;
a gate of the fifteenth transistor is electrically connected to the scan line, a first electrode of the fifteenth transistor is electrically connected to the data line, and a second electrode of the fifteenth transistor is electrically connected to the first node;
a gate of the sixteenth transistor is electrically connected to the scan line, a first electrode of the sixteenth transistor is electrically connected to the control terminal of the driving circuit, and a second electrode of the sixteenth transistor is electrically connected to the second node;
a first terminal of the first storage capacitor is electrically connected to the control terminal of the driving circuit, and a second terminal of the first storage capacitor is electrically connected to the power supply voltage terminal.

Optionally, the first initialization circuit includes a seventeenth transistor, and the second initialization circuit includes an eighteenth transistor;
a gate of the seventeenth transistor is electrically connected to the first control terminal, a first electrode of the seventeenth transistor is electrically connected to the initial voltage terminal, and a second electrode of the seventeenth transistor is electrically connected to the control terminal of the driving circuit;
a gate of the eighteenth transistor is electrically connected to the first control terminal, a first electrode of the eighteenth transistor is electrically connected to the initial voltage terminal, and a second electrode of the eighteenth transistor is electrically connected to the first electrode of the light emitting element.

Optionally, the light emitting control circuit includes a nineteenth transistor;
a gate of the nineteenth transistor is electrically connected to the second light emitting time control terminal, a first electrode of the nineteenth transistor is electrically connected to the power supply voltage terminal, and a second electrode of the nineteenth transistor is electrically connected to the first node.

Optionally, the first initialization circuit includes a seventeenth transistor, and the second initialization circuit includes an eighteenth transistor;
a gate of the seventeenth transistor is electrically connected to the first reset control terminal, a first electrode of the seventeenth transistor is electrically connected to the initial voltage terminal, and a second electrode of the seventeenth transistor is electrically connected to the control terminal of the driving circuit;
a gate of the eighteenth transistor is electrically connected to the first reset control terminal, a first electrode of the eighteenth transistor is electrically connected to the initial voltage terminal, and a second electrode of the eighteenth transistor is electrically connected to the first electrode of the light emitting element.

Optionally, the compensation control circuit includes a sixteenth transistor, the data write circuit includes a fifteenth transistor, and the eighth energy storage circuit includes a second storage capacitor;
a first terminal of the second storage capacitor is electrically connected to the control terminal of the driving circuit;
a gate of the sixteenth transistor is electrically connected to the scan line, a first electrode of the sixteenth transistor is electrically connected to the control terminal of the driving circuit, and a second electrode of the sixteenth transistor is electrically connected to the second node;
a gate of the fifteenth transistor is electrically connected to the scan line, a first electrode of the fifteenth transistor is electrically connected to the data line, and a second electrode of the fifteenth transistor is electrically connected to the second terminal of the second storage capacitor.

Optionally, the reference voltage write circuit includes a nineteenth transistor and a twentieth transistor;
a gate of the nineteenth transistor is electrically connected to the first control terminal, a first electrode of the nineteenth transistor is electrically connected to the reference voltage terminal, and a second electrode of the nineteenth transistor is electrically connected to the second terminal of the eighth energy storage circuit;
a gate of the twentieth transistor is electrically connected to the second light emitting time control terminal, a first electrode of the twentieth transistor is electrically connected to the reference voltage terminal, and a second electrode of the twentieth transistor is electrically connected to the second terminal of the eighth energy storage circuit.

In at least one embodiment of the present disclosure, the light emitting element may be a micro light emitting diode, but is not limited thereto. In actual operation, the light emitting element may also be a mini light emitting diode, an organic light emitting diode, or other types of light emitting elements.

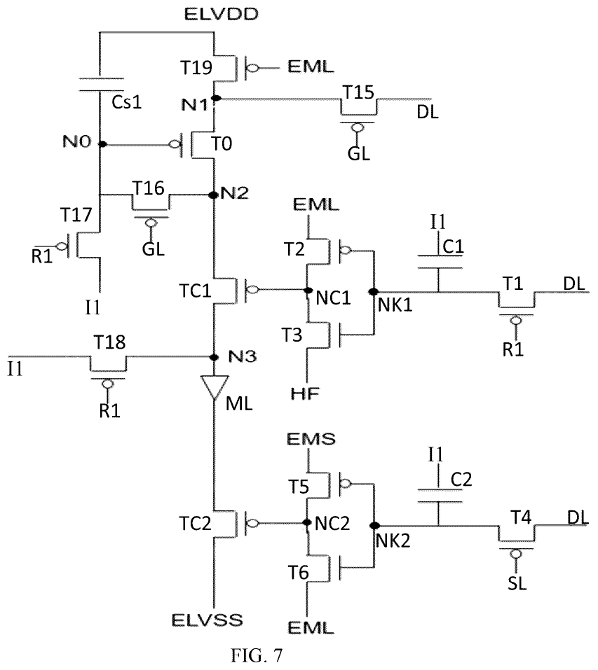

As shown in FIG. 7, based on at least one embodiment of the pixel circuit shown in FIG. 4, the light emitting element is a micro light emitting diode ML;
the first write circuit includes a first transistor T1, the first energy storage circuit includes a first capacitor C1, the first switch control circuit includes a second transistor T2, and the second switch control circuit includes a third transistor T3;
a gate of the first transistor T1 is electrically connected to the first control terminal R1, a source of the first transistor T1 is electrically connected to the data line DL, and a drain of the first transistor T1 is electrically connected to the first switch node NK1;
a first terminal of the first capacitor C1 is electrically connected to the first switch node NK1, and a second terminal of the first capacitor is electrically connected to the initial voltage terminal I1; the initial voltage terminal I1 is configured to provide an initial voltage Vinit;
a gate of the second transistor T2 is electrically connected to the first switch node NK1, a source of the second transistor T2 is electrically connected to the second light emitting time control terminal EML, and a drain of the second transistor T2 is electrically connected to the first control node NC1;
a gate of the third transistor T3 is electrically connected to the first switch node NK1, a source of the third transistor T3 is electrically connected to the first light emitting time control terminal HF, and a drain of the third transistor T3 is electrically connected to the first control node NC1;

T1 and T2 are p-type transistors, and T3 is an n-type transistor;
the second write circuit includes a fourth transistor T4, the second energy storage circuit includes a second capacitor C2, the third switch control circuit includes a fifth transistor T5, and the fourth switch control circuit includes a sixth transistor T6;
a gate of the fourth transistor T4 is electrically connected to the second control terminal SL, a source of the fourth transistor T4 is electrically connected to the data line DL, and a drain of the fourth transistor T4 is electrically connected to the second switch node NK2;
a first terminal of the second capacitor C2 is electrically connected to the second switch node NK2, and a second terminal of the second capacitor C2 is electrically connected to the initial voltage terminal I1;
a gate of the fifth transistor T5 is electrically connected to the second switch node NK2, a source of the fifth transistor T5 is electrically connected to the third light emitting time control terminal EMS, and a drain of the fifth transistor T5 is electrically connected to the second control node NC2;
a gate of the sixth transistor T6 is electrically connected to the second switch node NK2, a source of the sixth transistor T6 is electrically connected to the second light emitting time control terminal EML, and a drain of the sixth transistor T6 is electrically connected to the second control node NC2;
T4 and T5 are p-type transistors, and T6 is an n-type transistor;
the driving circuit includes a driving transistor T0;
a gate of the driving transistor T0 is connected to the driving control node N0, a source of the driving transistor T0 is electrically connected to the first node N1, and a drain of the driving transistor T0 is electrically connected to the second node N2;
the first on-off control circuit includes a first control transistor TC1, and the second on-off control circuit includes a second control transistor TC2;
a gate of the first control transistor TC1 is electrically connected to the first control node NC1, a source of the first control transistor TC1 is electrically connected to the second node N2, and a drain of the first control transistor TC1 is electrically connected to the third node N3; the third node N3 is electrically connected to the anode of the micro light emitting diode ML;
a gate of the second control transistor TC2 is electrically connected to the second control node NC2, a source of the second control transistor TC2 is electrically connected to the cathode of the micro light emitting diode ML, and a drain of the second control transistor TC2 is electrically connected to the low voltage terminal ELVSS;

T0 is a p-type transistor, TC1 and TC2 are p-type transistors;
the data write circuit includes a fifteenth transistor T15, the compensation control circuit includes a sixteenth transistor T16, and the seventh energy storage circuit includes a first storage capacitor Cs1;
a gate of the fifteenth transistor T15 is electrically connected to the scan line GL, a source of the fifteenth transistor T15 is electrically connected to the data line DL, and a drain of the fifteenth transistor T15 is electrically connected to the first node N1;
a gate of the sixteenth transistor T16 is electrically connected to the scan line GL, a source of the sixteenth transistor T16 is electrically connected to the driving control node N0, and a drain of the sixteenth transistor T16 is electrically connected to the second node N2;
T15 and T16 are p-type transistors;
a first terminal of the first storage capacitor Cs1 is electrically connected to the control terminal of the driving circuit 10, and a second terminal of the first storage capacitor Cs1 is electrically connected to the power supply voltage terminal ELVDD;
the first initialization circuit includes a seventeenth transistor T17, and the second initialization circuit includes an eighteenth transistor T18;
a gate of the seventeenth transistor T17 is electrically connected to the first control terminal R1, a source of the seventeenth transistor T17 is electrically connected to the initial voltage terminal I1, and a drain of the seventeenth transistor T17 is electrically connected to the driving control node N0;
a gate of the eighteenth transistor T18 is electrically connected to the first control terminal R1, a source of the eighteenth transistor T18 is electrically connected to the initial voltage terminal I1, and a drain of the eighteenth transistor T18 is electrically connected to the anode of the micro light emitting diode ML;
the light emitting control circuit includes a nineteenth transistor T19;
a gate of the nineteenth transistor T19 is electrically connected to the second light emitting time control terminal EML, a source of the nineteenth transistor T19 is electrically connected to the power supply voltage terminal ELVDD, and a drain of the nineteenth transistor T19 is electrically connected to the first node N1;
T17, T18, and T19 are p-type transistors.

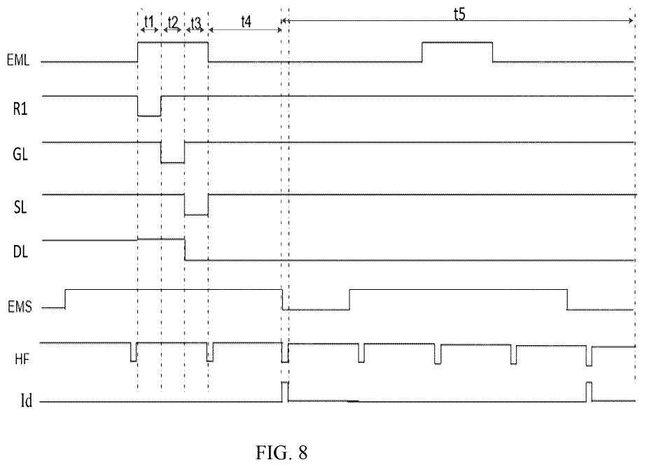

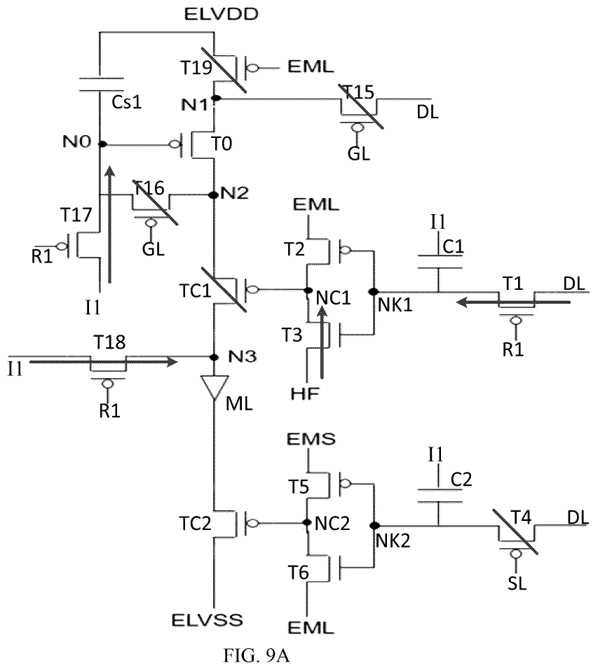

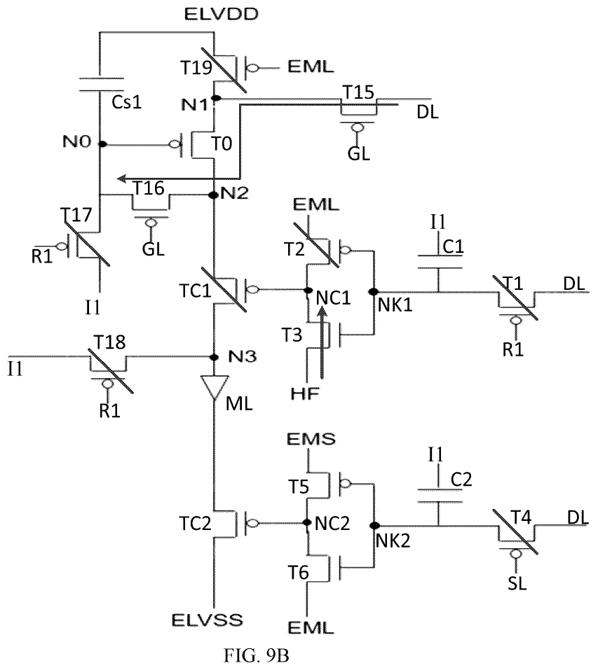

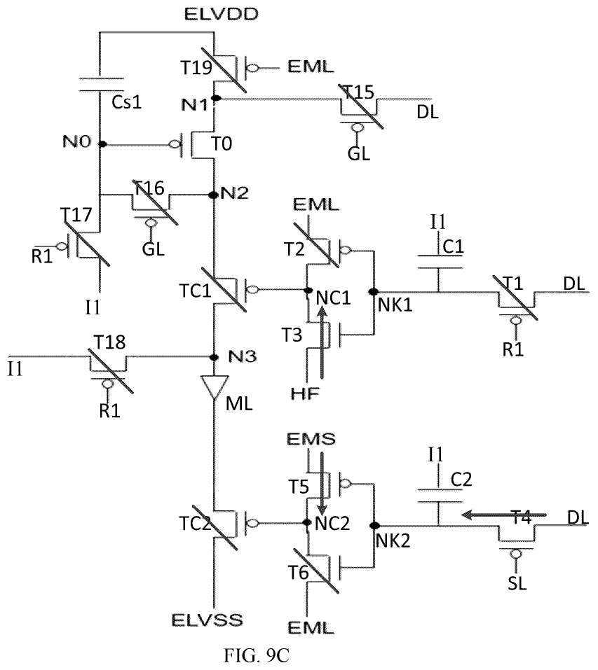

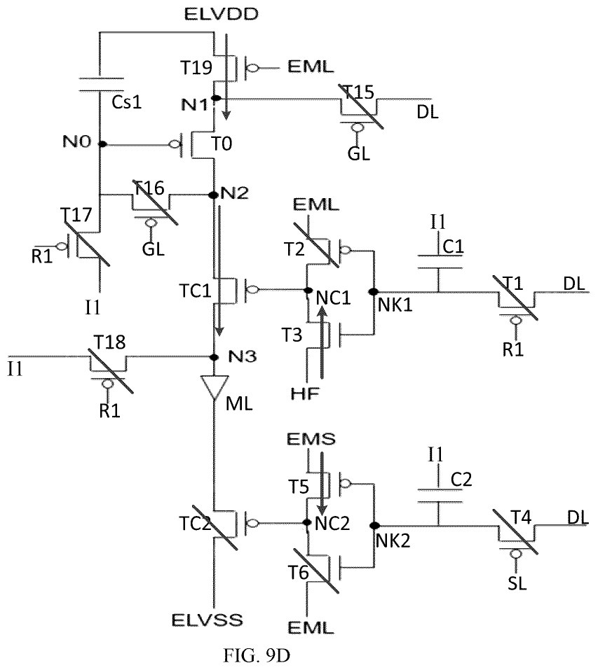

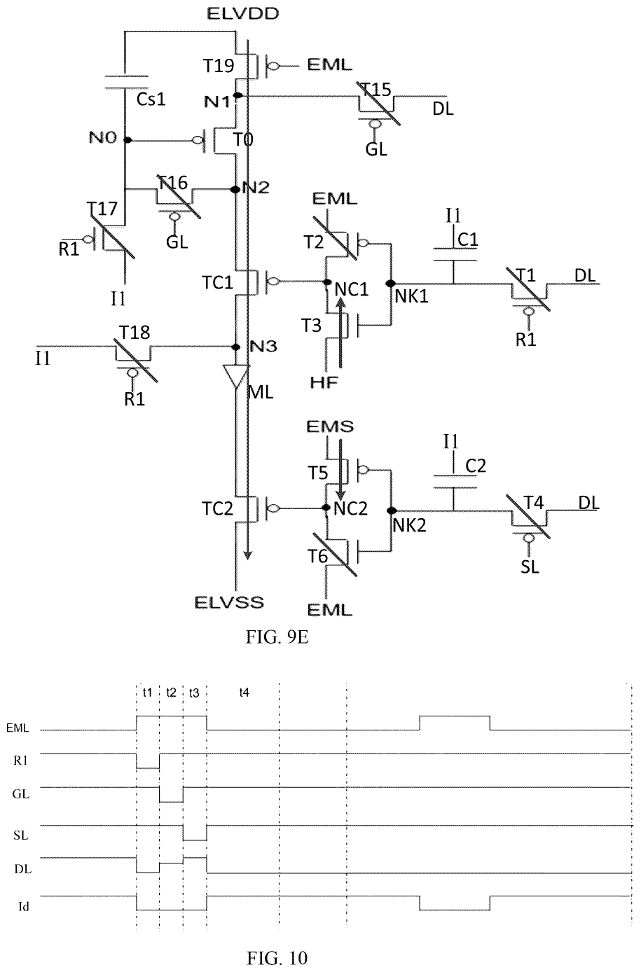

As shown in FIG. 8, when at least one embodiment of the pixel circuit shown in FIG. 7 of the present disclosure is in operation and an ultra-low grayscale is displayed, a display cycle includes a first stage t1, a second stage t2, a third stage t3, a fourth stage t4, and a fifth stage t5 that are sequentially arranged;
in the first stage t1, EML provides a high voltage signal, R1 provides a low voltage signal, GL provides a high voltage signal, SL provides a high voltage signal, DL provides a high voltage signal, EMS provides a high voltage signal, and HF provides a high voltage signal. As shown in FIG. 9A, T1 is turned on, C1 maintains the potential of NK1 at a high voltage, T3 is turned on, to control the connection between NC1 and HF, and TC1 is turned off; T17 is turned on to write the initial voltage Vinit into the driving control node N0, so that T0 may be turned on at the beginning of the second stage t2; T18 is turned on to write Vinit into the anode of ML to initialize the potential of the anode of ML and clear the residual charge in the anode of ML;

As shown in FIG. 9A, in the first stage t1, T19 is turned off, T16 is turned off, T15 is turned off, and T4 is turned off;
in the second stage t2, EML provides a high voltage signal, R1 provides a high voltage signal, GL provides a low voltage signal, SL provides a high voltage signal, DL provides a current control data voltage Vdata, EMS provides a high voltage signal, and HF provides a high voltage signal; as shown in FIG. 9B, C1 maintains the potential of NK1 at a high voltage, T3 is turned on, to control the connection between NC1 and HF, and TC1 is turned off; T15 is turned on, to write Vdata into the first node N1, and T16 is turned on;
at the beginning of the second stage t2, T0 is turned on, to charge Cs1 through Vdata until T0 is turned off and the potential of N0 becomes Vdata+Vth, where Vth is the threshold voltage of T0;

As shown in FIG. 9B, in the second stage t2, T19 is turned off, T17 is turned off, T18 is turned off, T1 is turned off, and T4 is turned off;
in the third stage t3, EML provides a high voltage signal, R1 provides a high voltage signal, GL provides a high voltage signal, SL provides a low voltage signal, DL provides a low voltage signal, EMS provides a high voltage signal, and HF provides a high voltage signal; as shown in FIG. 9C, T4 is turned on, C2 maintains the potential of NK2 at a low voltage, T5 is turned on, to control the connection between NK2 and EMS, so that the potential of NK2 is a high voltage, and TC2 is turned off;

As shown in FIG. 9C, in the third stage t3, T19 is turned off, T15 is turned off, T17 is turned off, T16 is turned off, T18 is turned off, TC1 is turned off, T1 is turned off, T2 is turned off, and T6 is turned off;
in the fourth stage t4, EML provides a low voltage signal, R1 provides a high voltage signal, GL provides a high voltage signal, SL provides a high voltage signal, DL provides a low voltage signal, and EMS provides a high voltage signal; as shown in FIG. 9D, T19 is turned on, C1 maintains the potential of NK1 at a high voltage, T3 is turned on, to control the connection between HF and NC1; when HF provides a low voltage signal, TC1 is turned on; C2 maintains the potential of NK2 at a low voltage, T5 is turned on, NC2 is connected to EMS, TC2 is turned off, and O1 does not emit light;

As shown in FIG. 9D, T15 is turned off, T17 is turned off, T18 is turned off, T16 is turned off, T1 is turned off, T2 is turned off, T4 is turned off, and T6 is turned off;
in the fifth stage t5, R1 provides a high voltage signal, GL provides a high voltage signal, and SL provides a high voltage signal; as shown in FIG. 9E, T3 is turned on, HF is connected to NC1, T5 is turned on, and EMS is connected to NC2, as shown in FIG. 9E, when EML, HF, and EMS all provide low voltage signals, T0 drives O1 to emit light;

As shown in FIG. 9E, T2 is turned off, T1 is turned off, T4 is turned off, T6 is turned off, T16 is turned off, T17 is turned off, and T17 is turned off.

The first stage t1 may be an initialization stage and a first data write stage, the second stage t2 may be a second data write stage and a compensation stage, the third stage t3 may be a third data write time, as well as a long-time light emitting and short-time light emitting selection time, the fourth stage t4 may be a light emitting selection stage, and the fifth stage t5 may be a light emitting stage.

In FIG. 8, the driving current labeled Id is generated by the driving transistor T0.

When at least one embodiment of the pixel circuit shown in FIG. 7 of the present disclosure is in operation, in the second stage t2, the Vdata written by DL determines the light emitting current, and the value range of Vdata may be greater than or equal to 12V and less than or equal to 18V. In the first stage t1 and the third stage t3, the voltage value of the voltage signal written by DL controls the corresponding transistor to be turned on or off. When the voltage signal written by DL controls the n-type transistor to be turned on, the voltage value of the voltage signal may be greater than or equal to 14V and less than or equal to 18V. When the voltage signal written by DL controls the p-type transistor to be turned on, the voltage value of the voltage signal may be greater than or equal to −2V and less than or equal to 0V.

In at least one embodiment of the present disclosure, the voltage value of the low voltage signal provided by ELVSS may be 2V, and the voltage value of the power supply voltage signal provided by ELVDD may be 16V, but the present disclosure is not limited thereto.

When at least one embodiment of the pixel circuit shown in FIG. 7 of the present disclosure is in operation, in the second stage t2,
when a medium-high grayscale is displayed, the voltage value of Vdata provided by DL may be greater than or equal to 12V and less than or equal to 15V;
when a medium-low grayscale is displayed, the voltage value of Vdata provided by DL may be greater than or equal to 15V and less than or equal to 18V;
but it is not limited to this.

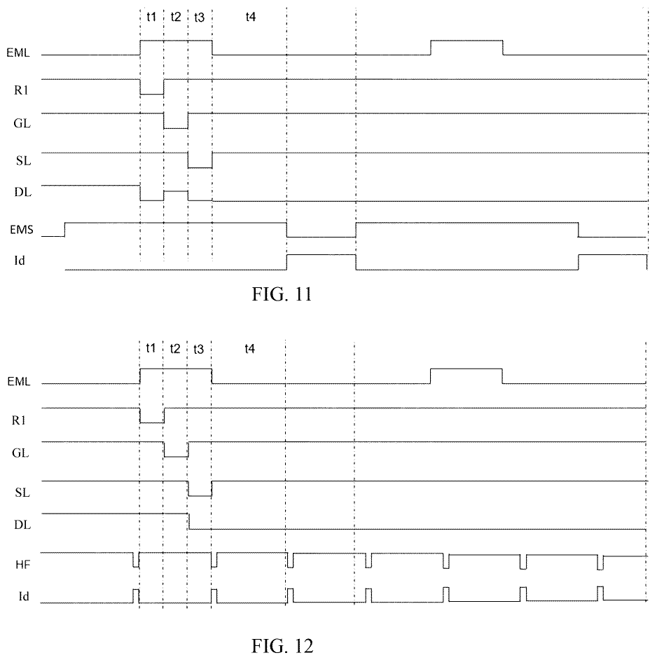

FIG. 10 is an operation timing diagram of at least one embodiment of the pixel circuit shown in FIG. 7 of the present disclosure when a medium-high grayscale is displayed. FIG. 11 is an operation timing diagram of at least one embodiment of the pixel circuit shown in FIG. 7 of the present disclosure when a medium-low grayscale is displayed.

FIG. 12 is an operation timing diagram of at least one embodiment of the pixel circuit shown in FIG. 7 of the present disclosure when a low grayscale is displayed.

As shown in FIG. 10, when at least one embodiment of the pixel circuit shown in FIG. 7 of the present disclosure displays a medium-high grayscale,
in the first stage t1, DL provides a low voltage signal, T2 is turned on, and EML is connected to NC1;
in the third stage t3, DL provides a high voltage signal, T6 is turned on, and EML is connected to NC2.

As shown in FIG. 11, when at least one embodiment of the pixel circuit shown in FIG. 7 of the present disclosure displays a medium-low grayscale,
in the first stage t1, DL provides a low voltage signal, T2 is turned on, and EML is connected to NC1;
in the third stage t3, DL provides a low voltage signal, T5 is turned on, and EMS is connected to NC2.

As shown in FIG. 12, when at least one embodiment of the pixel circuit shown in FIG. 7 of the present disclosure displays a low grayscale,
in the first stage t1, DL provides a high voltage signal, T3 is turned on, and HF is connected to NC1;
in the third stage t3, DL provides a low voltage signal, T5 is turned on, and EMS is connected to NC2.

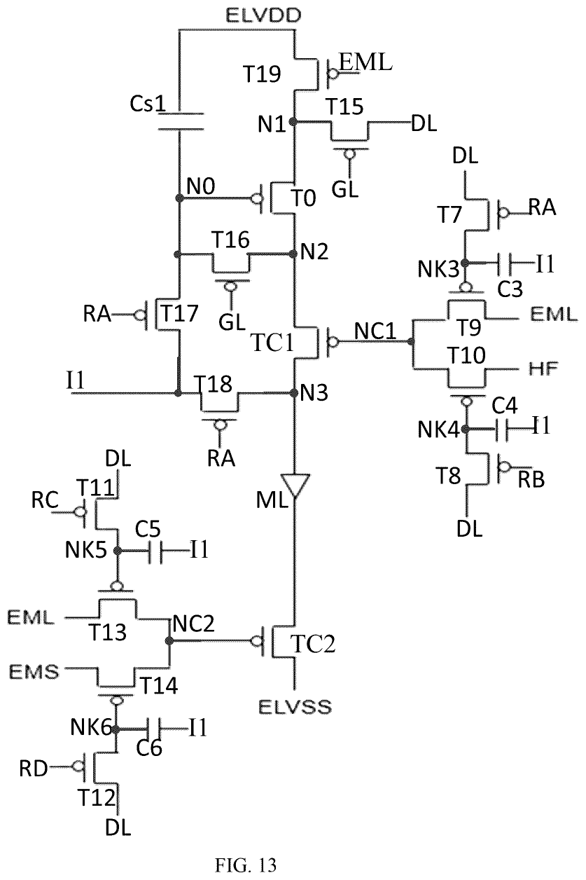

As shown in FIG. 13, based on at least one embodiment of the pixel circuit shown in FIG. 5, the light emitting element is a micro light emitting diode ML;
the third write circuit includes a seventh transistor T7, the fourth write circuit includes an eighth transistor T8, the third energy storage circuit includes a third capacitor C3, the fourth energy storage circuit includes a fourth capacitor C4, the fifth switch control circuit includes a ninth transistor T9, and the sixth switch control circuit includes a tenth transistor T10;
a gate of the seventh transistor T7 is electrically connected to the first reset control terminal RA, a source of the seventh transistor T7 is electrically connected to the data line DL, and a drain of the seventh transistor T7 is electrically connected to the third switch node NK3;
a first terminal of the third capacitor C3 is electrically connected to the third switch node NK3, and a second terminal of the third capacitor C3 is electrically connected to the initial voltage terminal I1; the initial voltage terminal I1 is configured to provide an initial voltage Vinit;
a gate of the eighth transistor TS is electrically connected to the second reset control terminal RB, a source of the eighth transistor T8 is electrically connected to the data line DL, and a drain of the eighth transistor T8 is electrically connected to the fourth switch node NK4;
a first terminal of the fourth capacitor C4 is electrically connected to the fourth switch node NK4, and a second terminal of the fourth capacitor C4 is electrically connected to the initial voltage terminal I1;
a gate of the ninth transistor T9 is electrically connected to the third switch node NK3, a source of the ninth transistor T9 is electrically connected to the second light emitting time control terminal EML, and a drain of the ninth transistor T9 is electrically connected to the first control node NC1;
a gate of the tenth transistor T10 is electrically connected to the fourth switch node NK4, a source of the tenth transistor T10 is electrically connected to the first light emitting time control terminal HF, and a drain of the tenth transistor T10 is electrically connected to the first control node NC1;
the fifth write circuit includes an eleventh transistor T11, the sixth write circuit includes a twelfth transistor T12, the seventh switch control circuit includes a thirteenth transistor T13, the eighth switch control circuit includes a fourteenth transistor T14, the fifth energy storage circuit includes a fifth capacitor C5, and the sixth energy storage circuit includes a sixth capacitor C6;
a gate of the eleventh transistor T11 is electrically connected to the third reset control terminal RC, a source of the eleventh transistor T11 is electrically connected to the data line DL, and a drain of the eleventh transistor T11 is electrically connected to the fifth switch node NK5;
a first terminal of the fifth capacitor C5 is electrically connected to the fifth switch node NK5, and a second terminal of the fifth capacitor C5 is electrically connected to the initial voltage terminal I1;
a gate of the twelfth transistor T12 is electrically connected to the fourth reset control terminal RD, a source of the twelfth transistor T12 is electrically connected to the data line DL, and a drain of the twelfth transistor T12 is electrically connected to the sixth switch node NK6;
a first terminal of the sixth capacitor C6 is electrically connected to the sixth switch node NK6, and a second terminal of the sixth capacitor C6 is electrically connected to the initial voltage terminal I1;
a gate of the thirteenth transistor T13 is electrically connected to the fifth switch node NK5, a source of the thirteenth transistor T13 is electrically connected to the second light emitting time control terminal EML, and a drain of the thirteenth transistor T13 is electrically connected to the second control node NC2;
a gate of the fourteenth transistor T14 is electrically connected to the sixth switch node NK6, a source of the fourteenth transistor T14 is electrically connected to the third light emitting time control terminal EMS, and a drain of the fourteenth transistor T14 is electrically connected to the second control node NC2;
the driving circuit includes a driving transistor T0;
a gate of the driving transistor T0 is connected to the driving control node N0, a source of the driving transistor T0 is electrically connected to the first node N1, and a drain of the driving transistor T0 is electrically connected to the second node N2;
the first on-off control circuit includes a first control transistor TC1, and the second on-off control circuit includes a second control transistor TC2;
a gate of the first control transistor TC1 is electrically connected to the first control node NC1, a source of the first control transistor TC1 is electrically connected to the second node N2, and a drain of the first control transistor TC1 is electrically connected to the third node N3; the third node N3 is electrically connected to the anode of the micro light emitting diode ML;
a gate of the second control transistor TC2 is electrically connected to the second control node NC2, a source of the second control transistor TC2 is electrically connected to the cathode of the micro light emitting diode ML, and a drain of the second control transistor TC2 is electrically connected to the low voltage terminal ELVSS;
the data write circuit includes a fifteenth transistor T15, the compensation control circuit includes a sixteenth transistor T16, and the seventh energy storage circuit includes a first storage capacitor Cs1;
a gate of the fifteenth transistor T15 is electrically connected to the scan line GL, a source of the fifteenth transistor T15 is electrically connected to the data line DL, and a drain of the fifteenth transistor T15 is electrically connected to the first node N1;
a gate of the sixteenth transistor T16 is electrically connected to the scan line GL, a source of the sixteenth transistor T16 is electrically connected to the driving control node N0, and a drain of the sixteenth transistor T16 is electrically connected to the second node N2;
a first terminal of the first storage capacitor Cs1 is electrically connected to the driving control node N0, and a second terminal of the first storage capacitor Cs1 is electrically connected to the power supply voltage terminal ELVDD;
the first initialization circuit includes a seventeenth transistor T17, and the second initialization circuit includes an eighteenth transistor T18;
a gate of the seventeenth transistor T17 is electrically connected to the first reset control terminal RA, a source of the seventeenth transistor T17 is electrically connected to the initial voltage terminal I1, and a drain of the seventeenth transistor T17 is electrically connected to the driving control node N0; the initial voltage terminal I1 is configured to provide an initial voltage Vinit;
a gate of the eighteenth transistor T18 is electrically connected to the first reset control terminal RA, a source of the eighteenth transistor T18 is electrically connected to the initial voltage terminal I1, and a drain of the eighteenth transistor T18 is electrically connected to the anode of the micro light emitting diode ML;
the light emitting control circuit includes a nineteenth transistor T19;
a gate of the nineteenth transistor T19 is electrically connected to the second light emitting time control terminal EML, a source of the nineteenth transistor T19 is electrically connected to the power supply voltage terminal ELVDD, and a drain of the nineteenth transistor T19 is electrically connected to the first node N1.

In at least one embodiment of the pixel circuit shown in FIG. 13, all transistors are p-type transistors, but the present disclosure is not limited thereto.

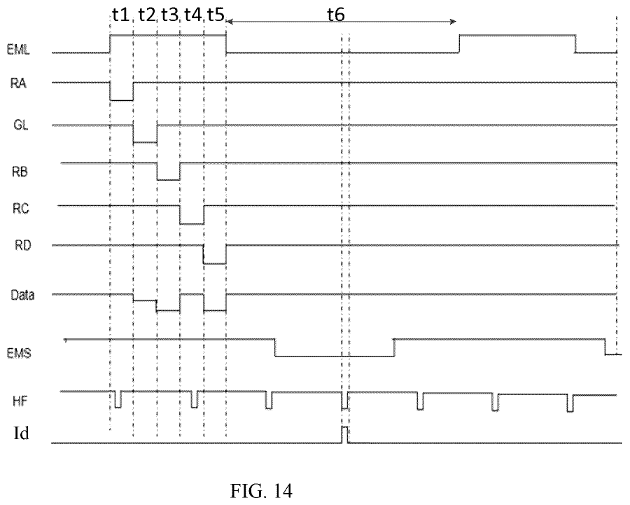

As shown in FIG. 14, when at least one embodiment of the pixel circuit shown in FIG. 13 of the present disclosure is in operation and an ultra-low grayscale is displayed, a display cycle includes a first stage t1, a second stage t2, a third stage t3, a fourth stage t4, a fifth stage t5, and a sixth stage to that are sequentially arranged;
in the first stage t1, RA provides a low voltage signal, T17 and T18 are turned on, and I1 provides an initial voltage Vinit to the driving control node N0 and the third node N3; DL provides a high voltage signal, T7 is turned on, the potential of NK3 is a high voltage, and T9 is turned off; RB, RC, and RD provide high voltage signals, EML provides a high voltage signal, T19 is turned off, GL provides a high voltage signal, and ML does not emit light;
in the second stage t2, EML provides a high voltage signal, T19 is still tumed off, EMS provides a high voltage signal, HF provides a high voltage signal, RA provides a high voltage signal, T17 and T18 are turned off, GL provides a low voltage signal, T15 and T16 are turned on, DL provides a current control data voltage Vdata, and N0 and N2 are connected to each other;
at the beginning of the second stage t2, T0 is turned on to charge Cs1 through Vdata until T0 is turned off and the potential of N0 is Vdata+Vth; Vth is the threshold voltage of T0;
in the third stage t3, EML provides a high voltage signal, T19 remains in the off state, RA, RC and RD all provide high voltage signals, T7, T11 and T12 are turned off, RB provides a low voltage signal, T8 is turned on, DL provides a low voltage signal, the potential of NK4 is a low voltage, T10 is turned on, NC1 and HF are connected to each other, HF provides a high voltage signal, and the potential of NC1 is a high voltage;
in the fourth stage t4, EML provides a high voltage signal, T19 remains off, RA, RB and RD all provide high voltage signals, T7, T8 and T12 are turned off, RC provides a low voltage signal, T11 is turned on, DL provides a high voltage signal, the potential of NK5 is a high voltage signal, and T13 is turned off;
in the fifth stage t5, EML provides a high voltage signal, T9 remains off, RA, RB and RC all provide high voltage signals, T7, T8 and T11 are all turned off, RD provides a low voltage signal, T12 is turned on, DL provides a low voltage signal, the potential of NK6 is a low voltage signal, T14 is turned on, NC2 is connected to EMS, and the potential of NC2 is a high voltage.

In the sixth stage t6, RA, RB, RC and RD all provide high voltage signals, GL provides a high voltage signal, EML provides a low voltage signal, T19 is turned on, C3 and C5 maintain the potential of NK3 and the potential of NK5 at high voltages, C4 and C6 maintain the potential of NK4 and the potential of NK6 at low voltages, T10 and T14 are turned on, when HF and EMS provide low voltage signals at the same time, the potential of NC1 and the potential of NC2 are low voltages, TC1 and TC2 are turned on, and T0 drives O1 to emit light.

When at least one embodiment of the pixel circuit shown in FIG. 13 of the present disclosure displays a medium-low grayscale,
in the first stage, RA provides a low voltage signal, RB provides a high voltage signal, RC and RD both provide high voltage signals, DL provides a low voltage signal, T7 and T9 are turned on, and EML is connected to NC1;
in the third stage, RC provides a high voltage signal, RD provides a low voltage signal, RA and RB both provide high voltage signals, DL provides a low voltage signal, T12 and T14 are turned on, and EMS is connected to NC2.

When at least one embodiment of the pixel circuit shown in FIG. 13 of the present disclosure displays a low grayscale,
in the first stage, RA provides a high voltage signal, RB provides a low voltage signal, RC and RD both provide high voltage signals, DL provides a low voltage signal, T8 and T10 are turned on, and HF is connected to NC1;
in the third stage, RC provides a high voltage signal, RD provides a low voltage signal, RA and RB both provide high voltage signals, DL provides a low voltage signal, T12 and T14 are turned on, and EMS is connected to NC2.

In at least one embodiment of the pixel circuit shown in FIG. 13 of the present disclosure, the gate of T17 and the gate of T18 may also be replaced to be electrically connected to the first control terminal R1.

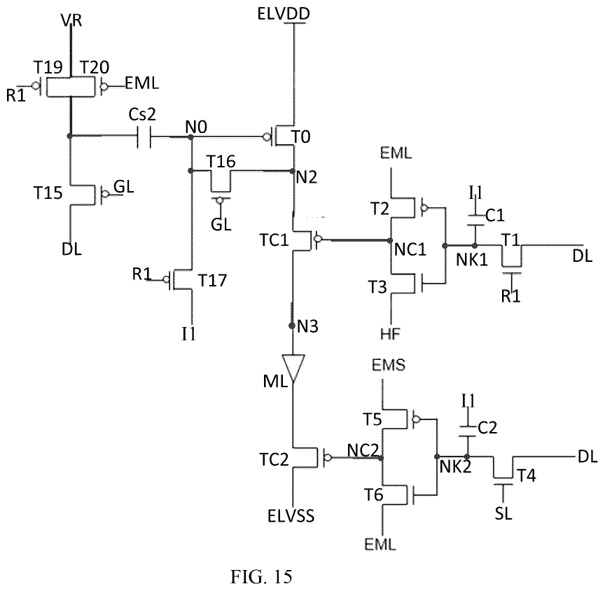

As shown in FIG. 15, based on at least one embodiment of the pixel circuit shown in FIG. 6, the light emitting element is a micro light emitting diode ML;
the first write circuit includes a first transistor T1, the first energy storage circuit includes a first capacitor C1, the first switch control circuit includes a second transistor T2, and the second switch control circuit includes a third transistor T3;
a gate of the first transistor T1 is electrically connected to the first control terminal R1, a source of the first transistor T1 is electrically connected to the data line DL, and a drain of the first transistor T1 is electrically connected to the first switch node NK1;
a first terminal of the first capacitor C1 is electrically connected to the first switch node NK1, and a second terminal of the first capacitor is electrically connected to the initial voltage terminal I1; the initial voltage terminal I1 is configured to provide an initial voltage Vinit;
a gate of the second transistor T2 is electrically connected to the first switch node NK1, a source of the second transistor T2 is electrically connected to the second light emitting time control terminal EML, and a drain of the second transistor T2 is electrically connected to the first control node NC1;
a gate of the third transistor T3 is electrically connected to the first switch node NK1, a source of the third transistor T3 is electrically connected to the first light emitting time control terminal HF, and a drain of the third transistor T3 is electrically connected to the first control node NC1;
T1 and T2 are p-type transistors, and T3 is an n-type transistor;
the second write circuit includes a fourth transistor T4, the second energy storage circuit includes a second capacitor C2, the third switch control circuit includes a fifth transistor T5, and the fourth switch control circuit includes a sixth transistor T6;
a gate of the fourth transistor T4 is electrically connected to the second control terminal SL, a source of the fourth transistor T4 is electrically connected to the data line DL, and a drain of the fourth transistor T4 is electrically connected to the second switch node NK2;
a first terminal of the second capacitor C2 is electrically connected to the second switch node NK2, and a second terminal of the second capacitor C2 is electrically connected to the initial voltage terminal I1;
a gate of the fifth transistor T5 is electrically connected to the second switch node NK2, a source of the fifth transistor T5 is electrically connected to the third light emitting time control terminal EMS, and a drain of the fifth transistor TS is electrically connected to the second control node NC2;
a gate of the sixth transistor T6 is electrically connected to the second switch node NK2, a source of the sixth transistor T6 is electrically connected to the second light emitting time control terminal EML, and a drain of the sixth transistor T6 is electrically connected to the second control node NC2;
T4 and T5 are p-type transistors, and T6 is an n-type transistor;
the driving circuit includes a driving transistor T0;
a gate of the driving transistor T0 is connected to the driving control node N0, a source of the driving transistor T0 is electrically connected to the power supply voltage terminal ELVDD, and a drain of the driving transistor T0 is electrically connected to the second node N2;
the first on-off control circuit includes a first control transistor TC1, and the second on-off control circuit includes a second control transistor TC2;
a gate of the first control transistor TC1 is electrically connected to the first control node NC1, a source of the first control transistor TC1 is electrically connected to the second node N2, and a drain of the first control transistor TC1 is electrically connected to the third node N3; the third node N3 is electrically connected to the anode of the micro light emitting diode ML;
a gate of the second control transistor TC2 is electrically connected to the second control node NC2, a source of the second control transistor TC2 is electrically connected to the cathode of the micro light emitting diode ML, and a drain of the second control transistor TC2 is electrically connected to the low voltage terminal ELVSS;
T0 is a p-type transistor, TC1 and TC2 are p-type transistors;
the first initialization circuit includes a seventeenth transistor T17;
a gate of the seventeenth transistor T17 is electrically connected to the first control terminal R1, a source of the seventeenth transistor T17 is electrically connected to the initial voltage terminal I1, and a drain of the seventeenth transistor T17 is electrically connected to the driving control node N0;
T17 is a p-type transistor;
the compensation control circuit includes a sixteenth transistor T16, the data write circuit includes a fifteenth transistor T15, and the eighth energy storage circuit includes a second storage capacitor Cs2;
a first terminal of the second storage capacitor Cs2 is electrically connected to the driving control node N0;
a gate of the sixteenth transistor T16 is electrically connected to the scan line GL, a source of the sixteenth transistor T16 is electrically connected to the driving control node N0, and a drain of the sixteenth transistor T16 is electrically connected to the second node N2;
a gate of the fifteenth transistor T15 is electrically connected to the scan line GL, a source of the fifteenth transistor T15 is electrically connected to the data line DL, and a drain of the fifteenth transistor T15 is electrically connected to the second terminal of the second storage capacitor Cs2;
both T15 and T16 are p-type transistors;
the reference voltage write circuit includes a nineteenth transistor T19 and a twentieth transistor T20;
a gate of the nineteenth transistor T19 is electrically connected to the first control terminal R1, a source of the nineteenth transistor T19 is electrically connected to the reference voltage terminal VR, and a drain of the nineteenth transistor T19 is electrically connected to the second terminal of the second storage capacitor Cs2;
a gate of the twentieth transistor T20 is electrically connected to the second light emitting time control terminal EML, a source of the twentieth transistor T20 is electrically connected to the reference voltage terminal VR, and a drain of the twentieth transistor T20 is electrically connected to the second terminal of the second storage capacitor Cs2;
both T19 and T20 are p-type transistors.

When at least one embodiment of the driving circuit shown in FIG. 15 of the present disclosure is in operation and an ultra-low grayscale is displayed, a display cycle includes a first stage, a second stage, a third stage, a fourth stage, and a fifth stage 15 that are sequentially arranged;
in the first stage, EML provides a high voltage signal, R1 provides a low voltage signal, GL provides a high voltage signal, SL provides a high voltage signal, DL provides a high voltage signal, EMS provides a high voltage signal, HF provides a high voltage signal, T1 is turned on, C1 maintains the potential of NK1 at a high voltage, T3 is turned on, to control the connection between NC1 and HF, and TC1 is turned off; T17 is turned on, to write the initial voltage Vinit into the driving control node N0, so that T0 may be turned on when the second stage t2 starts; VR provides a reference voltage Vref, and T19 is turned on, to write Vref into the second terminal of Cs2;
in the second stage, EML provides a high voltage signal, R1 provides a high voltage signal, GL provides a low voltage signal, SL provides a high voltage signal, DL provides a current control data voltage Vdata, EMS provides a high voltage signal, and HF provides a high voltage signal; C1 maintains the potential of NK1 at a high voltage, T3 is turned on, to control the connection between NC1 and HF, and TC1 is turned off; T15 is turned on, to write Vdata into the second terminal of C2, and T16 is turned on;
at the beginning of the second stage, T0 is turned on, to charge Cs2 until T0 is turned off and the potential of N0 becomes Vdd+Vth, where Vdd is the voltage value of the power supply voltage signal provided by ELVDD and Vth is the threshold voltage of T0;
in the third stage, EML provides a high voltage signal, R1 provides a high voltage signal, GL provides a high voltage signal, SL provides a low voltage signal, DL provides a low voltage signal, EMS provides a high voltage signal, and HF provides a high voltage signal; T4 is turned on, C2 maintains the potential of NK2 at a low voltage, T5 is turned on, controlling the connection between NK2 and EMS, so that the potential of NK2 is a high voltage, and TC2 is turned off;
in the fourth stage, EML provides a low voltage signal, R1 provides a high voltage signal, GL provides a high voltage signal, SL provides a high voltage signal, DL provides a low voltage signal, EMS provides a high voltage signal, T19 is turned on, C1 maintains the potential of NK1 at a high voltage, T3 is turned on, to control the connection between HF and NC1; when HF provides a low voltage signal, TC1 is turned on; C2 maintains the potential of NK2 at a low voltage, T5 is turned on, NC2 is connected to EMS, TC2 is turned off, and O1 does not emit light;
in the fourth stage, VR provides the reference voltage Vref, EML provides a low voltage signal, T20 is turned on, the potential of Cs2 changes from Vdata to Vref, and the potential of N0 changes to Vdd+Vth+Vref-Vdata;
in the fifth stage, R1 provides a high voltage signal, GL provides a high voltage signal, SL provides a high voltage signal, T3 is turned on, HF is connected to NC1, T5 is turned on, EMS is connected to NC2, and when EML, HF and EMS all provide low voltage signals, T0 drives O1 to emit light.

When at least one embodiment of the pixel circuit shown in FIG. 15 of the present disclosure displays a medium-high grayscale,
in the first stage, DL provides a low voltage signal, T2 is turned on, and EML is connected to NC1;
in the third stage, DL provides a high voltage signal, T6 is turned on, and EML is connected to NC2.

When at least one embodiment of the pixel circuit shown in FIG. 15 of the present disclosure displays a medium-low grayscale,
in the first stage, DL provides a low voltage signal, T2 is turned on, and EML is connected to NC1;
in the third stage, DL provides a low voltage signal, T5 is turned on, and EMS is connected to NC2.

When at least one embodiment of the pixel circuit shown in FIG. 15 of the present disclosure displays a low grayscale,
in the first stage, DL provides a high voltage signal, T3 is turned on, and HF is connected to NC1;
in the third stage, DL provides a low voltage signal, T5 is turned on, and EMS is connected to NC2.

The operating timing diagram of at least one embodiment of the pixel circuit shown in FIG. 15 of the present disclosure may be the same as the operating timing diagram of at least one embodiment of the pixel circuit shown in FIG. 7 of the present disclosure, but is not limited thereto.

An embodiment of the present disclosure provides a driving method, applied to the above-mentioned pixel circuit. The driving method includes:
a driving circuit generating a driving current for driving a light emitting element under control of a potential of a control terminal of the driving circuit;
a first on-off control circuit controlling connection or disconnection between a second node and a third node under control of a potential of a first control node;
a second on-off control circuit controlling connection or disconnection between a second electrode of the light emitting element and a first voltage terminal under control of a potential of a second control node;
a first control circuit controlling connection between a first light emitting time control terminal or a second light emitting time control terminal and the first control node according to a first time control data voltage provided by a data line under control of a first control signal;
a second control circuit controlling connection between the second light emitting time control terminal or a third light emitting time control terminal and the second control node according to a second time control data voltage provided by the data line under control of a second control signal.

An embodiment of the present disclosure provides a display device including the above-mentioned pixel circuit.

The above is a preferred embodiment of the present disclosure. It should be noted that for ordinary technicians in the art, several improvements and modifications may be made without departing from the principles described in the present disclosure. These improvements and modifications should also be regarded as the scope of protection of the present disclosure.

1. A pixel circuit, comprising a driving circuit, a first on-off control circuit, a light emitting element, a second on-off control circuit, a first control circuit, and a second control circuit; wherein,
a first terminal of the driving circuit is electrically connected to a first node, and a second terminal of the driving circuit is electrically connected to a second node; the driving circuit is configured to generate a driving current for driving the light emitting element under control of a potential of a control terminal of the driving circuit;
the first on-off control circuit is configured to control connection or disconnection between the second node and a third node under control of a potential of a first control node;
a first electrode of the light emitting element is electrically connected to the third node;
the second on-off control circuit is configured to control connection or disconnection between a second electrode of the light emitting element and a first voltage terminal under control of a potential of a second control node;
the first control circuit is electrically connected to a first control terminal, a data line, a first light emitting time control terminal, a second light emitting time control terminal, and the first control node respectively, and is configured to control connection between the first light emitting time control terminal or the second light emitting time control terminal and the first control node according to a first time control data voltage provided by the data line under control of a first control signal provided by the first control terminal;
the second control circuit is electrically connected to a second control terminal, the data line, the second light emitting time control terminal, a third light emitting time control terminal and the second control node respectively, and is configured to control connection between the second light emitting time control terminal or the third light emitting time control terminal and the second control node according to a second time control data voltage provided by the data line under control of a second control signal provided by the second control terminal.

2. The pixel circuit according to claim 1, wherein the first control circuit comprises a first write circuit, a first energy storage circuit, a first switch control circuit and a second switch control circuit;
the first write circuit is electrically connected to the first control terminal, the data line and a first switch node respectively, and is configured to write the first time control data voltage into the first switch node under control of the first control signal provided by the first control terminal;
the first energy storage circuit is electrically connected to the first switch node, and is configured to maintain a potential of the first switch node;
the first switch control circuit is electrically connected to the first switch node, the second light emitting time control terminal, and the first control node respectively, and is configured to control connection or disconnection between the first control node and the second light emitting time control terminal under control of the potential of the first switch node;
the second switch control circuit is electrically connected to the first switch node, the first light emitting time control terminal and the first control node respectively, and is configured to control connection or disconnection between the first control node and the first light emitting time control terminal under control of the potential of the first switch node.

3. The pixel circuit according to claim 1, wherein the second control circuit comprises a second write circuit, a second energy storage circuit, a third switch control circuit, and a fourth switch control circuit;
the second write circuit is electrically connected to the second control terminal, the data line, and a second switch node respectively, and is configured to write the second time control data voltage provided by the data line into the second switch node under control of the second control signal provided by the second control terminal;
the second energy storage circuit is electrically connected to the second switch node, and is configured to maintain a potential of the second switch node;
the third switch control circuit is electrically connected to the second switch node, the third light emitting time control terminal, and the second control node respectively, and is configured to control connection or disconnection between the second control node and the third light emitting time control terminal under control of the potential of the second switch node;
the fourth switch control circuit is electrically connected to the second switch node, the second light emitting time control terminal and the second control node respectively, and is configured to control connection or disconnection between the second control node and the second light emitting time control terminal under control of the potential of the second switch node.

4. The pixel circuit according to claim 1, wherein the first control circuit comprises a third write circuit, a fourth write circuit, a fifth switch control circuit, a sixth switch control circuit, a third energy storage circuit, and a fourth energy storage circuit; the first control terminal comprises a first reset control terminal and a second reset control terminal;
the third write circuit is electrically connected to the first reset control terminal, the data line and a third switch node respectively, and is configured to write a third time control data voltage provided by the data line into the third switch node under control of a first reset control signal provided by the first reset control terminal;
the third energy storage circuit is electrically connected to the third switch node, and is configured to maintain a potential of the third switch node;
the fourth write circuit is electrically connected to the second reset control terminal, the data line and a fourth switch node respectively, and is configured to write a fourth time control data voltage provided by the data line into the fourth switch node under control of a second reset control signal provided by the second reset control terminal;
the fourth energy storage circuit is electrically connected to the fourth switch node, and is configured to maintain a potential of the fourth switch node;
the fifth switch control circuit is electrically connected to the third switch node, the second light emitting time control terminal, and the first control node respectively, and is configured to control connection or disconnection between the second light emitting time control terminal and the first control node under control of the potential of the third switch node;
the sixth switch control circuit is electrically connected to the fourth switch node, the first light emitting time control terminal and the first control node respectively, and is configured to control connection or disconnection between the first light emitting time control terminal and the first control node under control of the potential of the fourth switch node.

5. The pixel circuit according to claim 1, wherein the second control circuit comprises a fifth write circuit, a sixth write circuit, a seventh switch control circuit, an eighth switch control circuit, a fifth energy storage circuit, and a sixth energy storage circuit; and the second control terminal comprises a third reset control terminal and a fourth reset control terminal;
the fifth write circuit is electrically connected to the third reset control terminal, the data line and a fifth switch node respectively, and is configured to write a fifth time control data voltage provided by the data line into the fifth switch node under control of a third reset control signal provided by the third reset control terminal;
the fifth energy storage circuit is electrically connected to the fifth switch node, and is configured to maintain a potential of the fifth switch node;
the sixth write circuit is electrically connected to the fourth reset control terminal, the data line and a sixth switch node respectively, and is configured to write a sixth time control data voltage provided by the data line into the sixth switch node under control of a fourth reset control signal provided by the fourth reset control terminal;
the sixth energy storage circuit is electrically connected to the sixth switch node, and is configured to maintain a potential of the sixth switch node;
the seventh switch control circuit is electrically connected to the fifth switch node, the second light emitting time control terminal, and the second control node respectively, and is configured to control connection or disconnection between the second light emitting time control terminal and the second control node under control of the potential of the fifth switch node;
the eighth switch control circuit is electrically connected to the sixth switch node, the third light emitting time control terminal and the second control node respectively, and is configured to control connection or disconnection between the third light emitting time control terminal and the second control node under control of the potential of the sixth switch node.

6. The pixel circuit according to claim 1, wherein the driving circuit comprises a driving transistor;
a gate of the driving transistor is electrically connected to the control terminal of the driving circuit, a first electrode of the driving circuit is electrically connected to the first node, and a second electrode of the driving circuit is electrically connected to the second node;
the first on-off control circuit comprises a first control transistor, and the second on-off control circuit comprises a second control transistor;
a gate of the first control transistor is electrically connected to the first control node, a first electrode of the first control transistor is electrically connected to the second node, and a second electrode of the first control transistor is electrically connected to the third node;
a gate of the second control transistor is electrically connected to the second control node, a first electrode of the second control transistor is electrically connected to a second electrode of the light emitting element, and a second electrode of the second control transistor is electrically connected to the first voltage terminal.

7. The pixel circuit according to claim 2, wherein the first write circuit comprises a first transistor, the first energy storage circuit comprises a first capacitor, the first switch control circuit comprises a second transistor, and the second switch control circuit comprises a third transistor;
a gate of the first transistor is electrically connected to the first control terminal, a first electrode of the first transistor is electrically connected to the data line, and a second electrode of the first transistor is electrically connected to the first switch node;
a first terminal of the first capacitor is electrically connected to the first switch node, and a second terminal of the first capacitor is electrically connected to an initial voltage terminal;
a gate of the second transistor is electrically connected to the first switch node, a first electrode of the second transistor is electrically connected to the second light emitting time control terminal, and a second electrode of the second transistor is electrically connected to the first control node;
a gate of the third transistor is electrically connected to the first switch node, a first electrode of the third transistor is electrically connected to the first light emitting time control terminal, and a second electrode of the third transistor is electrically connected to the first control node.

8. The pixel circuit according to claim 3, wherein the second write circuit comprises a fourth transistor, the second energy storage circuit comprises a second capacitor, the third switch control circuit comprises a fifth transistor, and the fourth switch control circuit comprises a sixth transistor;
a gate of the fourth transistor is electrically connected to the second control terminal, a first electrode of the fourth transistor is electrically connected to the data line, and a second electrode of the fourth transistor is electrically connected to the second switch node;
a first terminal of the second capacitor is electrically connected to the second switch node, and a second terminal of the second capacitor is electrically connected to the initial voltage terminal;
a gate of the fifth transistor is electrically connected to the second switch node, a first electrode of the fifth transistor is electrically connected to the third light emitting time control terminal, and a second electrode of the fifth transistor is electrically connected to the second control node;
a gate of the sixth transistor is electrically connected to the second switch node, a first electrode of the sixth transistor is electrically connected to the second light emitting time control terminal, and a second electrode of the sixth transistor is electrically connected to the second control node.

9. The pixel circuit according to claim 4, wherein the third write circuit comprises a seventh transistor, the fourth write circuit comprises an eighth transistor, the third energy storage circuit comprises a third capacitor, the fourth energy storage circuit comprises a fourth capacitor, the fifth switch control circuit comprises a ninth transistor, and the sixth switch control circuit comprises a tenth transistor;
a gate of the seventh transistor is electrically connected to the first reset control terminal, a first electrode of the seventh transistor is electrically connected to the data line, and a second electrode of the seventh transistor is electrically connected to the third switch node;
a first terminal of the third capacitor is electrically connected to the third switch node, and a second terminal of the third capacitor is electrically connected to the initial voltage terminal;
a gate of the eighth transistor is electrically connected to the second reset control terminal, a first electrode of the eighth transistor is electrically connected to the data line, and a second electrode of the eighth transistor is electrically connected to the fourth switch node;
a first terminal of the fourth capacitor is electrically connected to the fourth switch node, and a second terminal of the fourth capacitor is electrically connected to the initial voltage terminal;
a gate of the ninth transistor is electrically connected to the third switch node, a first electrode of the ninth transistor is electrically connected to the second light emitting time control terminal, and a second electrode of the ninth transistor is electrically connected to the first control node;
a gate of the tenth transistor is electrically connected to the fourth switch node, a first electrode of the tenth transistor is electrically connected to the first light emitting time control terminal, and a second electrode of the tenth transistor is electrically connected to the first control node.

10. The pixel circuit according to claim 5, wherein the fifth write circuit comprises an eleventh transistor, the sixth write circuit comprises a twelfth transistor, the seventh switch control circuit comprises a thirteenth transistor, the eighth switch control circuit comprises a fourteenth transistor, the fifth energy storage circuit comprises a fifth capacitor, and the sixth energy storage circuit comprises a sixth capacitor;
a gate of the eleventh transistor is electrically connected to the third reset control terminal, a first electrode of the eleventh transistor is electrically connected to the data line, and a second electrode of the eleventh transistor is electrically connected to the fifth switch node;
a first terminal of the fifth capacitor is electrically connected to the fifth switch node, and a second terminal of the fifth capacitor is electrically connected to the initial voltage terminal;
a gate of the twelfth transistor is electrically connected to the fourth reset control terminal, a first electrode of the twelfth transistor is electrically connected to the data line, and a second electrode of the twelfth transistor is electrically connected to the sixth switch node;
a first terminal of the sixth capacitor is electrically connected to the sixth switch node, and a second terminal of the sixth capacitor is electrically connected to the initial voltage terminal;
a gate of the thirteenth transistor is electrically connected to the fifth switch node, a first electrode of the thirteenth transistor is electrically connected to the second light emitting time control terminal, and a second electrode of the thirteenth transistor is electrically connected to the second control node;
a gate of the fourteenth transistor is electrically connected to the sixth switch node, a first electrode of the fourteenth transistor is electrically connected to the third light emitting time control terminal, and a second electrode of the fourteenth transistor is electrically connected to the second control node.

11. The pixel circuit according to claim 1, further comprising a data write circuit, a compensation control circuit and a seventh energy storage circuit; wherein,
the data write circuit is electrically connected to a scan line, the data line and the first node respectively, and is configured to write a current control data voltage provided by the data line into the first node under control of a scan signal provided by the scan line;
the compensation control circuit is electrically connected to the scan line, the control terminal of the driving circuit and the second node respectively, and is configured to control connection or disconnection between the control terminal of the driving circuit and the second node under control of the scan signal;
the seventh energy storage circuit is electrically connected to the control terminal of the driving circuit and is configured to store electric energy.

12. The pixel circuit according to claim 1, further comprising a first initialization circuit and a second initialization circuit; wherein,
the first initialization circuit is electrically connected to the first control terminal, the initial voltage terminal, and the control terminal of the driving circuit respectively, and is configured to write an initial voltage provided by the initial voltage terminal into the control terminal of the driving circuit under control of the first control signal provided by the first control terminal;
the second initialization circuit is electrically connected to the first control terminal, the initial voltage terminal and the first electrode of the light emitting element respectively, and is configured to write the initial voltage into the first electrode of the light emitting element under control of the first control signal;
wherein the first initialization circuit comprises a seventeenth transistor, and the second initialization circuit comprises an eighteenth transistor;
a gate of the seventeenth transistor is electrically connected to the first control terminal, a first electrode of the seventeenth transistor is electrically connected to the initial voltage terminal, and a second electrode of the seventeenth transistor is electrically connected to the control terminal of the driving circuit;
a gate of the eighteenth transistor is electrically connected to the first control terminal, a first electrode of the eighteenth transistor is electrically connected to the initial voltage terminal, and a second electrode of the eighteenth transistor is electrically connected to the first electrode of the light emitting element.

13. The pixel circuit according to claim 11, further comprising a light emitting control circuit; wherein,
the light emitting control circuit is electrically connected to the second light emitting time control terminal, a power supply voltage terminal and the first node respectively, and is configured to control connection between the power supply voltage terminal and the first node under control of the second light emitting time control signal provided by the second light emitting time control terminal;
wherein the light emitting control circuit comprises a nineteenth transistor;
a gate of the nineteenth transistor is electrically connected to the second light emitting time control terminal, a first electrode of the nineteenth transistor is electrically connected to the power supply voltage terminal, and a second electrode of the nineteenth transistor is electrically connected to the first node.

14. The pixel circuit according to claim 4, wherein the first control terminal comprises the first reset control terminal and the second reset control terminal;
the pixel circuit further comprises a first initialization circuit and a second initialization circuit;
the first initialization circuit is electrically connected to the first reset control terminal, the initial voltage terminal, and the control terminal of the driving circuit respectively, and is configured to write the initial voltage provided by the initial voltage terminal into the control terminal of the driving circuit under control of the first reset control signal provided by the first reset control terminal;
the second initialization circuit is electrically connected to the first reset control terminal, the initial voltage terminal and the first electrode of the light emitting element respectively, and is configured to write the initial voltage into the first electrode of the light emitting element under control of the first reset control signal;
wherein the first initialization circuit comprises a seventeenth transistor, and the second initialization circuit comprises an eighteenth transistor;
a gate of the seventeenth transistor is electrically connected to the first reset control terminal, a first electrode of the seventeenth transistor is electrically connected to the initial voltage terminal, and a second electrode of the seventeenth transistor is electrically connected to the control terminal of the driving circuit;
a gate of the eighteenth transistor is electrically connected to the first reset control terminal, a first electrode of the eighteenth transistor is electrically connected to the initial voltage terminal, and a second electrode of the eighteenth transistor is electrically connected to the first electrode of the light emitting element.

15. The pixel circuit according to claim 1, further comprising a compensation control circuit, a data write circuit, and an eighth energy storage circuit; wherein the first node is electrically connected to a power supply voltage terminal;
a first terminal of the eighth energy storage circuit is electrically connected to the control terminal of the driving circuit; and the eighth energy storage circuit is configured to store electrical energy;
the compensation control circuit is electrically connected to a scan line, the control terminal of the driving circuit, and the second node respectively, and is configured to control connection or disconnection between the control terminal of the driving circuit and the second node under control of a scan signal provided by the scan line;
the data write circuit is electrically connected to the scan line, the data line and a second terminal of the eighth energy storage circuit respectively, and is configured to write a current control data voltage provided by the data line into the second terminal of the eighth energy storage circuit under control of the scan signal.

16. The pixel circuit according to claim 15, further comprising a reference voltage write circuit;
the reference voltage write circuit is electrically connected to the first control terminal, the second light emitting time control terminal, a reference voltage terminal and the second terminal of the eighth energy storage circuit respectively, and is configured to write a reference voltage provided by the reference voltage terminal into the second terminal of the eighth energy storage circuit under control of the first control signal provided by the first control terminal, and to write the reference voltage into the second terminal of the eighth energy storage circuit under control of the second light emitting time control signal provided by the second light emitting time control terminal;
wherein the reference voltage write circuit comprises a nineteenth transistor and a twentieth transistor;
a gate of the nineteenth transistor is electrically connected to the first control terminal, a first electrode of the nineteenth transistor is electrically connected to the reference voltage terminal, and a second electrode of the nineteenth transistor is electrically connected to the second terminal of the eighth energy storage circuit;
a gate of the twentieth transistor is electrically connected to the second light emitting time control terminal, a first electrode of the twentieth transistor is electrically connected to the reference voltage terminal, and a second electrode of the twentieth transistor is electrically connected to the second terminal of the eighth energy storage circuit.

17. The pixel circuit according to claim 11, wherein the data write circuit comprises a fifteenth transistor, the compensation control circuit comprises a sixteenth transistor, and the seventh energy storage circuit comprises a first storage capacitor;
a gate of the fifteenth transistor is electrically connected to the scan line, a first electrode of the fifteenth transistor is electrically connected to the data line, and a second electrode of the fifteenth transistor is electrically connected to the first node;
a gate of the sixteenth transistor is electrically connected to the scan line, a first electrode of the sixteenth transistor is electrically connected to the control terminal of the driving circuit, and a second electrode of the sixteenth transistor is electrically connected to the second node;
a first terminal of the first storage capacitor is electrically connected to the control terminal of the driving circuit, and a second terminal of the first storage capacitor is electrically connected to a power supply voltage terminal.

18. (canceled)

19. (canceled)

20. (canceled)

21. The pixel circuit according to claim 15, wherein the compensation control circuit comprises a sixteenth transistor, the data write circuit comprises a fifteenth transistor, and the eighth energy storage circuit comprises a second storage capacitor;
a first terminal of the second storage capacitor is electrically connected to the control terminal of the driving circuit;
a gate of the sixteenth transistor is electrically connected to the scan line, a first electrode of the sixteenth transistor is electrically connected to the control terminal of the driving circuit, and a second electrode of the sixteenth transistor is electrically connected to the second node;
a gate of the fifteenth transistor is electrically connected to the scan line, a first electrode of the fifteenth transistor is electrically connected to the data line, and a second electrode of the fifteenth transistor is electrically connected to a second terminal of the second storage capacitor.

22. (canceled)

23. A driving method, applied to the pixel circuit according to claim 1, the driving method comprising:
a driving circuit generating a driving current for driving a light emitting element under control of a potential of a control terminal of the driving circuit;
a first on-off control circuit controlling connection or disconnection between a second node and a third node under control of a potential of a first control node;
a second on-off control circuit controlling connection or disconnection between a second electrode of the light emitting element and a first voltage terminal under control of a potential of a second control node;
a first control circuit controlling connection between a first light emitting time control terminal or a second light emitting time control terminal and the first control node according to a first time control data voltage provided by a data line under control of a first control signal;
a second control circuit controlling connection between the second light emitting time control terminal or a third light emitting time control terminal and the second control node according to a second time control data voltage provided by the data line under control of a second control signal.

24. A display device, comprising the pixel circuit according to claim 1.
